(19) United States
(12) Patent Application Publication
(10) Pub. No.: US 2026/0071015 A1
(43) Pub. Date: Mar. 12, 2026

(54) METHOD OF PRODUCING MULTIMODAL POLYETHYLENE USING AT LEAST ONE GROUP III-BASED OR LANTHANIDE-BASED BIPHENYLPHENOXY CATALYST

(71) Applicant: Dow Global Technologies LLC, Midland, MI (US)

(72) Inventors: Johnathan E. DeLorbe, Manvel, TX (US); Rhett A. Baillie, Missouri City, TX (US); Endre Szuromi, Lake Jackson, TX (US); Philip P. Fontaine, Pearland, TX (US); Rafael Huacuja, Rosharon, TX (US); Robert D. Grigg, Midland, MI (US); Sudipta Pal, Midland, MI (US); Jerzy Klosin, Midland, MI (US); Brad C. Bailey, Midland, MI (US)

(73) Assignee: Dow Global Technologies LLC, Midland, MI (US)

(21) Appl. No.: 19/105,256

(22) PCT Filed: Aug. 29, 2023
(86) PCT No.: PCT/US2023/073095

§ 371 Date: Feb. 20, 2025

Related U.S. Application Data
(60) Provisional application No. 63/401,924, filed on Aug. 29, 2022.

(51) Int. Cl. C08F 210/16; C08F 4/54; C08F 4/64; C08F 4/652

(52) U.S. Cl. CPC C08F 210/16; C08F 4/545; C08F 4/64168; C08F 4/652; C08F 2500/03; C08F 2500/12

(57) ABSTRACT

Embodiments of this disclosure are directed to catalyst systems comprising a metal-ligand complex according to formula (I):

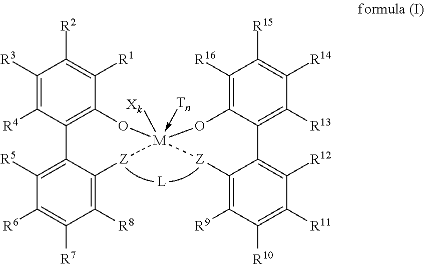

### CROSS-REFERENCE TO RELATED APPLICATIONS

This application claims the benefit of U.S. Provisional Application Ser. No. 63/401,924 filed Aug. 29, 2022, the entire disclosure of which is hereby incorporated herein by reference.

### TECHNICAL FIELD

Embodiments of the present disclosure generally relate to olefin polymerization catalyst systems and processes and, more specifically to bis-phenylphenoxy metal-ligand complexes having a Group III or Lanthanide metal center.

### BACKGROUND

Olefin-based polymers such as polyethylene, ethylene-based polymers, polypropylene, and propylene-based polymers are produced via various catalyst systems. Selection of such catalyst systems used in the polymerization process of the olefin-based polymers is an important factor contributing to the characteristics and properties of such olefin-based polymers.

Ethylene-based polymers and propylene-based polymers are manufactured for a wide variety of articles. The polyethylene and polypropylene polymerization process can be varied in a number of respects to produce a wide variety of resultant polyethylene resins having different physical properties that render the various resins suitable for use in different applications. The ethylene monomers and, optionally, one or more co-monomers are present in liquid diluents or solvents, such as alkanes or isoalkanes, of which hexane and isobutane are specific examples. Hydrogen may also be added to the reactor. The catalyst systems for producing ethylene-based polymers may typically comprise a chromium-based catalyst system, a Ziegler-Natta catalyst system, and/or a molecular (either metallocene or non-metallocene (molecular)) catalyst system. The reactants in the catalyst system and the diluent are circulated at an elevated polymerization temperature within the reactor, thereby producing ethylene-based homopolymer or copolymer. Either periodically or continuously, part of the reaction mixture is removed from the reactor, including the polyethylene product dissolved in the diluent, and unreacted ethylene and one or more optional co-monomers. The reaction mixture may be processed after removal from the reactor to remove the polyethylene product from the diluent and the unreacted reactants, and the diluent and unreacted reactants are typically recycled back into the reactor. Alternatively, the reaction mixture may be sent to a second reactor, serially connected to the first reactor, where a second polyethylene fraction may be produced. Despite the research efforts in developing catalyst systems suitable for olefin polymerization, such as polyethylene polymerization, there is still a need to increase the efficiencies of catalyst systems that have a high selectivity towards ethylene.

### SUMMARY

There is an ongoing need to create catalyst systems or metal-ligand complexes with a high selectivity toward ethylene during ethylene and α-olefin copolymerization reactions. Additionally, the metal-ligand complex should have high catalyst efficiency, and a versatile ability to produce polymers with a high or low molecular weight at high temperature (such as greater than 140° C. or approximately 190° C.).

Embodiments of this disclosure include polymerization processes. The polymerization process includes polymerizing ethylene and optionally one or more olefins in the presence of a catalyst system. The catalyst system includes at least one metal-ligand complex of formula (I), at least one group IV catalyst, at least one additive, and optionally a Lewis Acid. The polymerization process occurs in a solution polymerization reactor under olefin polymerizing conditions to form an ethylene-based polymer.

In one or more embodiments, the metal-ligand complex of formula (I) has a structure according to:

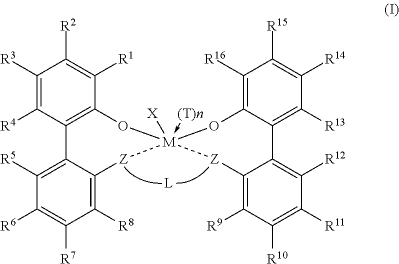

In formula (I), M is scandium, yttrium, a lanthanide metal or an actinide metal. Subscript n of Tₙ is 0, 1, or 2. T is a Lewis base. Subscript k of Xₖ is 1 or 2. X is a ligand chosen from (C₁-C₄₀)hydrocarbyl, (C₁-C₄₀)heterohydrocarbyl, —CH₂Si(R^{C})_{3-Q}(OR^{C})_{Q}, —Si(R^{C})_{3-Q}(OR^{C})_{Q}, —OSi(R^{C})_{3-Q}(OR^{C})_{Q}, —CH₂Ge(R^{C})_{3-Q}(OR^{C})_{Q}, —Ge(R^{C})_{3-Q}(OR^{C})_{Q}, —P(R^{C})_{2-W}(OR^{C})_{W}, —P(O)(R^{C})_{2-W}(OR^{C})_{W}, —N(R^{C})₂, —NH(R^{C}), —N(Si(R^{C})₃)₂, —NR^{C}Si(R^{C})₃, —NHSi(R^{C})₃, —OR^{C}, —SR^{C}, —NO₂, —CN, —CF₃, —OCF₃, —S(O)R^{C}, —S(O)₂R^{C}, —OS(O)₂R^{C}, —N═C(R^{C})₂, —N═CH(R^{C}), —N═CH₂, —N═P(R^{C})₃, —OC(O)R^{C}, —C(O)OR^{C}, —N(R^{C})C(O)R^{C}, —N(R^{C})C(O)H, —NHC(O)R^{C}, —C(O)N(R^{C})₂, —C(O)NHR^{C}, —C(O)NH₂, or a hydrogen, wherein each R^{C} is independently a substituted or unsubstituted (C₁-C₃₀)hydrocarbyl, or a substituted or unsubstituted (C₁-C₃₀)heterohydrocarbyl. Subscript Q is 0, 1, 2 or 3 and Subscript W is 0, 1, or 2. When subscript n of Tₙ is 1, X and T are optionally connected to form bidentate ligand. When subscript n of Tₙ is 1 and k of Xₖ is 2, each X and T are optionally connected to form bidentate ligand or tridentate ligand. The metal-ligand complex is overall charge-neutral.

In formula (I), R¹ and R¹⁶ are independently selected from the group consisting of —H, (C₁-C₄₀)hydrocarbyl, (C₁-C₄₀)heterohydrocarbyl, —Si(R^{C})₃, —Ge(R^{C})₃, —P(R^{P})₂, —N(R^{N})₂, —OR^{C}, —SR^{C}, —NO₂, —CN, —CF₃, R^{C}S(O)—, R^{C}S(O)₂—, —N═C(R^{C})₂, R^{C}C(O)O—, R^{C}OC(O)—, R^{C}C(O)N(R)—, (R^{C})₂NC(O)—, halogen, radicals having formula (II), radicals having formula (III), and radicals having formula (IV):

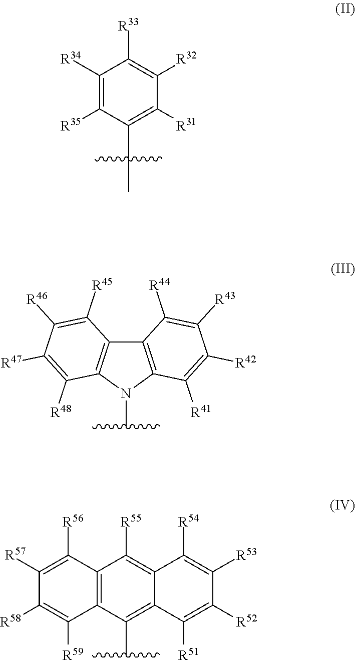

In formulas (II), (III), and (IV), each of R³¹⁻³⁵, R⁴¹⁻⁴⁸, and R⁵¹⁻⁵⁹ is independently chosen from —H, (C₁-C₄₀)hydrocarbyl, (C₁-C₄₀)heterohydrocarbyl, —Si(R^{C})₃, —Ge(R^{C})₃, —P(R^{P})₂, —N(R^{N})₂, —OR^{C}, —SR^{C}, —NO₂, —CN, —CF₃, R^{C}S(O)—, R^{C}S(O)₂—, (R^{C})₂C═N—, R^{C}C(O)O—, R^{C}OC(O)—, R^{C}C(O)N(R^{N})—, (R^{C})₂NC(O)—, or halogen.

In formula (I), R², R³, R⁴, R⁵, R⁶, R⁷, R⁸, R⁹, R¹⁰, R¹¹, R¹², R¹³, R¹⁴, and R¹⁵ is independently selected from —H, (C₁-C₄₀)hydrocarbyl, (C₁-C₄₀)heterohydrocarbyl, —Si(R^{C})₃, —Ge(R^{C})₃, —P(R^{P})₂, —N(R^{N})₂, —OR^{C}, —SR^{C}, —NO₂, —CN, —CF₃, R^{C}S(O)—, R^{C}S(O)₂—, (R^{C})₂C═N—, R^{C}C(O)O—, R^{C}OC(O)—, R^{C}C(O)N(R)—, (R^{C})₂NC(O)—, and halogen.

In formula (I), L is (C₁-C₄₀)hydrocarbylene or (C₁-C₄₀)heterohydrocarbylene; and each Z is independently chosen from —O—, —S—, —N(R^{N}), or —P(R^{P})—.

In formulas (I), (II), (III), and (IV), each R^{C}, R^{P}, and R^{N} is independently a (C₁-C₃₀)hydrocarbyl, (C₁-C₃₀)heterohydrocarbyl, or —H.

### DETAILED DESCRIPTION

Specific embodiments of catalyst systems will now be described. It should be understood that the catalyst systems of this disclosure may be embodied in different forms and should not be construed as limited to the specific embodiments set forth in this disclosure.

Common abbreviations are listed below:

R, Z, M, X and n: as defined above; Me: methyl; Et: ethyl; Ph: phenyl; Bn: benzyl; i-Pr: iso-propyl; t-Bu: tert-butyl; t-Oct: tert-octyl (2,4,4-trimethylpentan-2-yl); Tf trifluoromethane sulfonate; CV: column volume (used in column chromatography); EtOAc ethyl acetate; TEA: triethylaluminum; MAO: methylaluminoxane; MMAO: modified methylaluminoxane; LiCH₂TMS: (trimethylsilyl)methyllithium; TMS: trimethylsilyl; Pd(AmPhos)Cl₂: Bis(di-tert-butyl(4-dimethylaminophenyl)phosphine)dichloropalladium(II); Pd(AmPhos): Chloro(crotyl)(di-tert-butyl(4-dimethylaminophenyl)phosphine)palladium(II); Pd(dppf)Cl₂: [1,1′-Bis(diphenylphosphino)ferrocene]palladium(II) dichloride; ScCl₃: scandium(III) chloride; PhMe: toluene; THF: tetrahydrofuran; CH₂Cl₂: dichloromethane; DMF: N,N-dimethylformamide; EtOAc: ethyl acetate; Et₂O: diethyl ether; MeOH: methanol; NH₄Cl: ammonium chloride; MgSO₄: magnesium sulfate; Na₂SO₄: sodium sulfate; NaOH: sodium hydroxide; brine: saturated aqueous sodium chloride; SiO₂: silica; CDCl₃: chloroform-D; GC: gas chromatography; LC: liquid chromatography; NMR: nuclear magnetic resonance; MS: mass spectrometry; mmol: millimoles; mL: milliliters; M: molar; min or mins: minutes; h or hrs: hours; d: days; TLC; thin layered chromatography; rpm: revolution per minute; rt: room temperature.

The term “independently selected” is used herein to indicate that the R groups, such as, R¹, R², R³, R⁴, and R⁵, can be identical or different (e.g., R¹, R², R³, R⁴, and R⁵ may all be substituted alkyls or R¹ and R² may be a substituted alkyl and R³ may be an aryl, etc.) A chemical name associated with an R group is intended to convey the chemical structure that is recognized in the art as corresponding to that of the chemical name. Thus, chemical names are intended to supplement and illustrate, not preclude, the structural definitions known to those of skill in the art.

When used to describe certain carbon atom-containing chemical groups, a parenthetical expression having the form “(Cₓ-C_{y})” means that the unsubstituted form of the chemical group has from x carbon atoms to y carbon atoms, inclusive of x and y. For example, a (C₁-C₅₀)alkyl is an alkyl group having from 1 to 50 carbon atoms in its unsubstituted form. In some embodiments and general structures, certain chemical groups may be substituted by one or more substituents such as R^{S}. An R^{S} substituted chemical group defined using the “(Cₓ-C_{y})” parenthetical may contain more than y carbon atoms depending on the identity of any groups R^{S}. For example, a “(C₁-C₅₀)alkyl substituted with exactly one group R^{S}, where R^{S} is phenyl (—C₆H₅)” may contain from 7 to 56 carbon atoms. Thus, in general when a chemical group defined using the “(Cₓ-C_{y})” parenthetical is substituted by one or more carbon atom-containing substituents R^{S}, the minimum and maximum total number of carbon atoms of the chemical group is determined by adding to both x and y the combined sum of the number of carbon atoms from all of the carbon atom-containing substituents R^{S}.

The term “substitution” means that at least one hydrogen atom (—H) bonded to a carbon atom or heteroatom of a corresponding unsubstituted compound or functional group is replaced by a substituent (e.g. R^{S}). The term “persubstitution” means that every hydrogen atom (H) bonded to a carbon atom or heteroatom of a corresponding unsubstituted compound or functional group is replaced by a substituent (e.g., R^{S}). The term “polysubstitution” means that at least two, but fewer than all, hydrogen atoms bonded to carbon atoms or heteroatoms of a corresponding unsubstituted compound or functional group are replaced by a substituent. The term “—H” means a hydrogen or hydrogen radical that is covalently bonded to another atom. “Hydrogen” and “—H” are interchangeable, and unless clearly specified have identical meanings.

The term “(C₁-C₅₀)hydrocarbyl” means a hydrocarbon radical of from 1 to 50 carbon atoms and the term “(C₁-C₅₀)hydrocarbylene” means a hydrocarbon diradical of from 1 to 50 carbon atoms, in which each hydrocarbon radical and each hydrocarbon diradical is aromatic or non-aromatic, saturated or unsaturated, straight chain or branched chain, cyclic (having three carbons or more, and including mono- and poly-cyclic, fused and non-fused polycyclic, and bicyclic) or acyclic, and substituted by one or more R^{S} or unsubstituted.

In this disclosure, a (C₁-C₅₀)hydrocarbyl may be an unsubstituted or substituted (C₁-C₅₀)alkyl, (C₃-C₅₀)cycloalkyl, (C₃-C₂₀)cycloalkyl-(C₁-C₂₀)alkylene, (C₆-C₄₀)aryl, or (C₆-C₂₀)aryl-(C₁-C₂₀)alkylene (such as benzyl (—CH₂—C₆H₅)).

The terms “(C₁-C₅₀)alkyl” and “(C₁-C₁₈)alkyl” mean a saturated straight or branched hydrocarbon radical of from 1 to 50 carbon atoms and a saturated straight or branched hydrocarbon radical of from 1 to 18 carbon atoms, respectively, that is unsubstituted or substituted by one or more R^{S}. Examples of unsubstituted (C₁-C₅₀)alkyl are unsubstituted (C₁-C₂₀)alkyl; unsubstituted (C₁-C₁₀)alkyl; unsubstituted (C₁-C₅)alkyl; methyl; ethyl; 1-propyl; 2-propyl; 1-butyl; 2-butyl; 2-methylpropyl; 1,1-dimethylethyl; 1-pentyl; 1-hexyl; 1-heptyl; 1-nonyl; and 1-decyl. Examples of substituted (C₁-C₄₀)alkyl are substituted (C₁-C₂₀)alkyl, substituted (C₁-C₁₀)alkyl, trifluoromethyl, and [C₄₅]alkyl. The term “[C₄₅]alkyl” means there is a maximum of 45 carbon atoms in the radical, including substituents, and is, for example, a (C₂₇-C₄₀)alkyl substituted by one R^{S}, which is a (C₁-C₅)alkyl, respectively. Each (C₁-C₅)alkyl may be methyl, trifluoromethyl, ethyl, 1-propyl, 1-methylethyl, or 1,1-dimethylethyl.

The term “(C₆-C₅₀)aryl” means an unsubstituted or substituted (by one or more R^{S}) monocyclic, bicyclic, or tricyclic aromatic hydrocarbon radical of from 6 to 40 carbon atoms, of which at least from 6 to 14 of the carbon atoms are aromatic ring carbon atoms. A monocyclic aromatic hydrocarbon radical includes one aromatic ring; a bicyclic aromatic hydrocarbon radical has two rings; and a tricyclic aromatic hydrocarbon radical has three rings. When the bicyclic or tricyclic aromatic hydrocarbon radical is present, at least one of the rings of the radical is aromatic. The other ring or rings of the aromatic radical may be independently fused or non-fused and aromatic or non-aromatic. Examples of unsubstituted (C₆-C₅₀)aryl include: unsubstituted (C₆-C₂₀)aryl, unsubstituted (C₆-C₁₈)aryl; 2-(C₁-C₅)alkyl-phenyl; phenyl; fluorenyl; tetrahydrofluorenyl; indacenyl; hexahydroindacenyl; indenyl; dihydroindenyl; naphthyl; tetrahydronaphthyl; and phenanthrene. Examples of substituted (C₆-C₄₀)aryl include: substituted (C₁-C₂₀)aryl; substituted (C₆-C₁₈)aryl; 2,4-bis([C₂₀]alkyl)-phenyl; polyfluorophenyl; pentafluorophenyl; and fluoren-9-one-1-yl.

The term “(C₃-C₅₀)cycloalkyl” means a saturated cyclic hydrocarbon radical of from 3 to 50 carbon atoms that is unsubstituted or substituted by one or more R^{S}. Other cycloalkyl groups (e.g., (Cₓ-C_{y})cycloalkyl) are defined in an analogous manner as having from x to y carbon atoms and being either unsubstituted or substituted with one or more R^{S}. Examples of unsubstituted (C₃-C₄₀)cycloalkyl are unsubstituted (C₃-C₂₀)cycloalkyl, unsubstituted (C₃-C₁₀)cycloalkyl, cyclopropyl, cyclobutyl, cyclopentyl, cyclohexyl, cycloheptyl, cyclooctyl, cyclononyl, and cyclodecyl. Examples of substituted (C₃-C₄₀)cycloalkyl are substituted (C₃-C₂₀)cycloalkyl, substituted (C₃-C₁₀)cycloalkyl, cyclopentanon-2-yl, and 1-fluorocyclohexyl.

Examples of (C₁-C₅₀)hydrocarbylene include unsubstituted or substituted (C₆-C₅₀)arylene, (C₃-C₅₀)cycloalkylene, and (C₁-C₅₀)alkylene (e.g., (C₁-C₂₀)alkylene). The diradicals may be on the same carbon atom (e.g., —CH₂—) or on adjacent carbon atoms (i.e., 1,2-diradicals), or are spaced apart by one, two, or more than two intervening carbon atoms (e.g., 1,3-diradicals, 1,4-diradicals, etc.). Some diradicals include 1,2-, 1,3-, 1,4-, or an α,ω-diradical, and others a 1,2-diradical. The α,ω-diradical is a diradical that has maximum carbon backbone spacing between the radical carbons. Some examples of (C₂-C₂₀)alkylene α,ω-diradicals include ethan-1,2-diyl (i.e. —CH₂CH₂—), propan-1,3-diyl (i.e. —CH₂CH₂CH₂—), 2-methylpropan-1,3-diyl (i.e. —CH₂CH(CH₃)CH₂—). Some examples of (C₆-C₅₀)arylene α,ω-diradicals include phenyl-1,4-diyl, napthalen-2,6-diyl, or napthalen-3,7-diyl.

The term “(C₁-C₅₀)alkylene” means a saturated straight chain or branched chain diradical (i.e., the radicals are not on ring atoms) of from 1 to 50 carbon atoms that is unsubstituted or substituted by one or more R^{S}. Examples of unsubstituted (C₁-C₅₀)alkylene are unsubstituted (C₁-C₂₀)alkylene, including unsubstituted —CH₂CH₂—, —(CH₂)₃—, —(CH₂)₄—, —(CH₂)₅—, —(CH₂)₆—, —(CH₂)₇—, —(CH₂)₈—, —CH₂C*HCH₃, and —(CH₂)₄C*(H)(CH₃), in which “C*” denotes a carbon atom from which a hydrogen atom is removed to form a secondary or tertiary alkyl radical. Examples of substituted (C₁-C₅₀)alkylene are substituted (C₁-C₂₀)alkylene, —CF₂—, —C(O)—, and —(CH₂)₁₄C(CH₃)₂(CH₂)₅— (i.e., a 6,6-dimethyl substituted normal-1,20-eicosylene). Since as mentioned previously two R^{S} may be taken together to form a (C₁-C₁₈)alkylene, examples of substituted (C₁-C₅₀)alkylene also include 1,2-bis(methylene)cyclopentane, 1,2-bis(methylene)cyclohexane, 2,3-bis(methylene)-7,7-dimethyl-bicyclo[2.2.1]heptane, and 2,3-bis (methylene)bicyclo [2.2.2] octane.

The term “(C₃-C₅₀)cycloalkylene” means a cyclic diradical (i.e., the radicals are on ring atoms) of from 3 to 50 carbon atoms that either is unsubstituted or is substituted by one or more R^{S}.

The term “heteroatom,” refers to an atom other than hydrogen or carbon. Examples of groups containing one or more than one heteroatom include O, S, S(O), S(O)₂, Si(R^{C})₂, P(R^{P}), N(R^{N}), —N═C(R^{C})₂, —Ge(R^{C})₂—, —Si(R^{C})—, boron (B), aluminum (Al), gallium (Ga), or indium (In), where each R^{C} and each R^{P} is unsubstituted (C₁-C₁₈)hydrocarbyl or —H, and where each R^{N} is unsubstituted (C₁-C₁₈)hydrocarbyl. The term “heterohydrocarbon” refers to a molecule or molecular framework in which one or more carbon atoms of a hydrocarbon are replaced with a heteroatom. The term “(C₁-C₅₀)heterohydrocarbyl” means a heterohydrocarbon radical of from 1 to 50 carbon atoms, and the term “(C₁-C₅₀)heterohydrocarbylene” means a heterohydrocarbon diradical of from 1 to 50 carbon atoms. The heterohydrocarbon of the (C₁-C₅₀)heterohydrocarbyl or the (C₁-C₅₀)heterohydrocarbylene has one or more heteroatoms. The radical of the heterohydrocarbyl may be on a carbon atom or a heteroatom. The two radicals of the heterohydrocarbylene may be on a single carbon atom or on a single heteroatom. Additionally, one of the two radicals of the diradical may be on a carbon atom and the other radical may be on a different carbon atom; one of the two radicals may be on a carbon atom and the other on a heteroatom; or one of the two radicals may be on a heteroatom and the other radical on a different heteroatom. Each (C₁-C₅₀)heterohydrocarbyl and (C₁-C₅₀)heterohydrocarbylene may be unsubstituted or substituted (by one or more R^{S}), aromatic or non-aromatic, saturated or unsaturated, straight chain or branched chain, cyclic (including mono- and poly-cyclic, fused and non-fused polycyclic), or acyclic.

The (C₁-C₅₀)heterohydrocarbyl may be unsubstituted or substituted. Non-limiting examples of the (C₁-C₅₀)heterohydrocarbyl include (C₁-C₅₀)heteroalkyl, (C₁-C₅₀)hydrocarbyl-O—, (C₁-C₅₀)hydrocarbyl-S—, (C₁-C₅₀)hydrocarbyl-S(O)—, (C₁-C₅₀)hydrocarbyl-S(O)₂—, (C₁-C₅₀)hydrocarbyl-Si(R^{C})₂—, (C₁-C₅₀)hydrocarbyl-N(R^{N}), (C₁-C₅₀)hydrocarbyl-P(R^{P})—, (C₂-C₅₀)heterocycloalkyl, (C₂-C₁₉)heterocycloalkyl-(C₁-C₂₀)alkylene, (C₃-C₂₀)cycloalkyl-(C₁-C₁₉)heteroalkylene, (C₂-C₁₉)heterocycloalkyl-(C₁-C₂₀)heteroalkylene, (C₁-C₅₀)heteroaryl, (C₁-C₁₉)heteroaryl-(C₁-C₂₀)alkylene, (C₆-C₂₀)aryl-(C₁-C₁₉)heteroalkylene, or (C₁-C₁₉)heteroaryl-(C₁-C₂₀)heteroalkylene.

The term “(C₁-C₅₀)heteroaryl” means an unsubstituted or substituted (by one or more R^{S}) mono-, bi-, or tricyclic heteroaromatic hydrocarbon radical of from 1 to 50 total carbon atoms and from 1 to 10 heteroatoms. A monocyclic heteroaromatic hydrocarbon radical includes one heteroaromatic ring; a bicyclic heteroaromatic hydrocarbon radical has two rings; and a tricyclic heteroaromatic hydrocarbon radical has three rings. When the bicyclic or tricyclic heteroaromatic hydrocarbon radical is present, at least one of the rings in the radical is heteroaromatic. The other ring or rings of the heteroaromatic radical may be independently fused or non-fused and aromatic or non-aromatic. Other heteroaryl groups (e.g., (Cₓ-C_{y})heteroaryl generally, such as (C₁-C₁₂)heteroaryl) are defined in an analogous manner as having from x to y carbon atoms (such as 1 to 12 carbon atoms) and being unsubstituted or substituted by one or more than one R^{S}. The monocyclic heteroaromatic hydrocarbon radical is a 5-membered ring or a 6-membered ring. The 5-membered ring monocyclic heteroaromatic hydrocarbon radical has 5 minus h carbon atoms, where h is the number of heteroatoms and may be 1, 2, 3, or 4; and each heteroatom may be O, S, N, or P. Examples of 5-membered ring heteroaromatic hydrocarbon radicals include pyrrol-1-yl; pyrrol-2-yl; furan-3-yl; thiophen-2-yl; pyrazol-1-yl; isoxazol-2-yl; isothiazol-5-yl; imidazol-2-yl; oxazol-4-yl; thiazol-2-yl; 1,2,4-triazol-1-yl; 1,3,4-oxadiazol-2-yl; 1,3,4-thiadiazol-2-yl; tetrazol-1-yl; tetrazol-2-yl; and tetrazol-5-yl. The 6-membered ring monocyclic heteroaromatic hydrocarbon radical has 6 minus h carbon atoms, where h is the number of heteroatoms and may be 1 or 2 and the heteroatoms may be N or P. Examples of 6-membered ring heteroaromatic hydrocarbon radicals include pyridine-2-yl; pyrimidin-2-yl; and pyrazin-2-yl. The bicyclic heteroaromatic hydrocarbon radical can be a fused 5,6- or 6,6-ring system. Examples of the fused 5,6-ring system bicyclic heteroaromatic hydrocarbon radical are indol-1-yl; and benzimidazole-1-yl. Examples of the fused 6,6-ring system bicyclic heteroaromatic hydrocarbon radical are quinolin-2-yl; and isoquinolin-1-yl. The tricyclic heteroaromatic hydrocarbon radical can be a fused 5,6,5-; 5,6,6-; 6,5,6-; or 6,6,6-ring system. An example of the fused 5,6,5-ring system is 1,7-dihydropyrrolo[3,2-f]indol-1-yl. An example of the fused 5,6,6-ring system is 1H-benzo[f]indol-1-yl. An example of the fused 6,5,6-ring system is 9H-carbazol-9-yl. An example of the fused 6,6,6-ring system is acrydin-9-yl.

The term “(C₁-C₅₀)heteroalkyl” means a saturated straight or branched chain radical containing one to fifty carbon atoms and one or more heteroatom. The term “(C₁-C₅₀)heteroalkylene” means a saturated straight or branched chain diradical containing from 1 to 50 carbon atoms and one or more than one heteroatoms. The heteroatoms of the heteroalkyls or the heteroalkylenes may include Si(R^{C})₃, Ge(R^{C})₃, Si(R^{C})₂, Ge(R^{C})₂, P(R^{P})₂, P(R^{P}), N(R^{N})₂, N(R^{N}), N, O, OR^{C}, S, SR^{C}, S(O), and S(O)₂, wherein each of the heteroalkyl and heteroalkylene groups are unsubstituted or are substituted by one or more R^{S}.

Examples of unsubstituted (C₂-C₄₀)heterocycloalkyl include unsubstituted (C₂-C₂₀)heterocycloalkyl, unsubstituted (C₂-C₁₀)heterocycloalkyl, aziridin-1-yl, oxetan-2-yl, tetrahydrofuran-3-yl, pyrrolidin-1-yl, tetrahydrothiophen-S,S-dioxide-2-yl, morpholin-4-yl, 1,4-dioxan-2-yl, hexahydroazepin-4-yl, 3-oxa-cyclooctyl, 5-thio-cyclononyl, and 2-aza-cyclodecyl.

The term “halogen atom” or “halogen” means the radical of a fluorine atom (F), chlorine atom (Cl), bromine atom (Br), or iodine atom (I). The term “halide” means anionic form of the halogen atom: fluoride (F⁻), chloride (Cl⁻), bromide (Br⁻), or iodide (I⁻).

The term “saturated” means lacking carbon-carbon double bonds, carbon-carbon triple bonds, and (in heteroatom-containing groups) carbon-nitrogen, carbon-phosphorous, and carbon-silicon double bonds. Where a saturated chemical group is substituted by one or more substituents R^{S}, one or more double and/or triple bonds optionally may be present in substituents R^{S}. The term “unsaturated” means containing one or more carbon-carbon double bonds or carbon-carbon triple bonds, or (in heteroatom-containing groups) one or more carbon-nitrogen double bonds, carbon-phosphorous double bonds, or carbon-silicon double bonds, not including double bonds that may be present in substituents R^{S}, if any, or in aromatic rings or heteroaromatic rings, if any.

The term “lanthanide metal” includes elements 57 through 71 (lanthanum (La) to lutetium (Lu)).

Embodiments of this disclosure include polymerization processes. The polymerization process includes polymerizing ethylene and optionally one or more olefins in the presence of a first catalyst system and a second catalyst system. The catalyst system includes at least one metal-ligand complex of formula (I), at least one group IV catalyst, at least one additive, and optionally a Lewis Acid. The polymerization process occurs in a solution polymerization reactor under olefin polymerizing conditions to form an ethylene-based polymer,

In one or more embodiments, the metal-ligand complex of formula (I) has a structure according to:

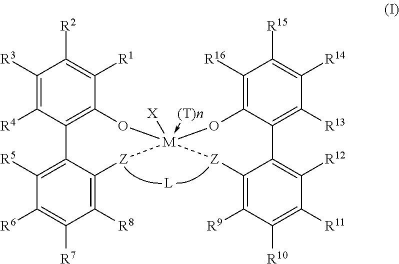

In formula (I), M is scandium, yttrium, a lanthanide metal or an actinide metal. Subscript n of Tₙ is 0, 1, or 2, subscript k of Xₖ is 1 or 2, and X is a ligand chosen from (C₁-C₄₀)hydrocarbyl, (C₁-C₄₀)heterohydrocarbyl, —CH₂Si(R^{C})_{3-Q}(OR^{C})_{Q}, —Si(R^{C})_{3-Q}(OR^{C})_{Q}, —OSi(R^{C})_{3-Q}(OR^{C})_{Q}, —CH₂Ge(R^{C})_{3-Q}(OR^{C})_{Q}, —Ge(R^{C})_{3-Q}(OR^{C})_{Q}, —P(R^{C})_{2-W}(OR^{C})_{W}, —P(O)(R^{C})_{2-W}(OR^{C})_{W}, —N(R^{C})₂, —NH(R^{C}), —N(Si(R^{C})₃)₂, —NR^{C}Si(R^{C})₃, —NHSi(R^{C})₃, —OR^{C}, —SR^{C}, —NO₂, —CN, —CF₃, —OCF₃, —S(O)R^{C}, —S(O)₂R^{C}, —OS(O)₂R^{C}, —N═C(R^{C})₂, —N═CH(R^{C}), —N═CH₂, —N═P(R^{C})₃, —OC(O)R^{C}, —C(O)OR^{C}, —N(R^{C})C(O)R^{C}, —N(R^{C})C(O)H, —NHC(O)R^{C}, —C(O)N(R^{C})₂, —C(O)NHR^{C}, —C(O)NH₂, or a hydrogen. Each R^{C} is independently a substituted or unsubstituted (C₁-C₃₀)hydrocarbyl, or a substituted or unsubstituted (C₁-C₃₀)heterohydrocarbyl. Subscript Q is 0, 1, 2 or 3 and subscript W is 0, 1, or 2. T is a Lewis base. When subscript n of Tₙ is 1, X and T are optionally connected to form a bidentate ligand. When subscript n of Tₙ is 1 and k of Xₖ is 2, each X and T are optionally connected to form bidentate ligand or a tridentate ligand. The metal-ligand complex is overall charge-neutral.

In formula (I), R¹ and R¹⁶ are independently selected from the group consisting of —H, (C₁-C₄₀)hydrocarbyl, (C₁-C₄₀)heterohydrocarbyl, —Si(R^{C})₃, —Ge(R^{C})₃, —P(R^{P})₂, —N(R^{N})₂, —OR^{C}, —SR^{C}, —NO₂, —CN, —CF₃, R^{C}S(O)—, R^{C}S(O)₂—, —N═C(R^{C})₂, R^{C}C(O)O—, R^{C}OC(O)—, R^{C}C(O)N(R)—, (R^{C})₂NC(O)—, halogen, radicals having formula (II), radicals having formula (III), and radicals having formula (IV):

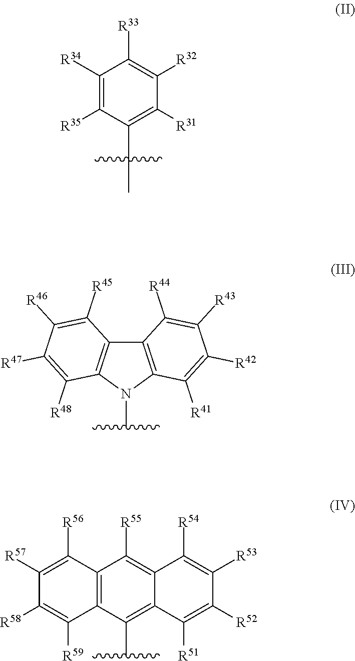

In some embodiments, in the metal-ligand complex of formula (I), either one of R¹ or R¹⁶, or both R¹ and R¹⁶, are chosen from radicals having formula (II), formula (III), or formula (IV). With the proviso that when M is yttrium or a lanthanide metal, R¹ is not —H, phenyl or tert-butyl; and R¹⁶ is not —H, phenyl or tert-butyl.

When present in the metal-ligand complex of formula (I) as part of a radical having formula (II), formula (III), or formula (IV), the groups R³¹⁻³⁵, R⁴¹⁻⁴⁸, and R⁵¹⁻⁵⁹ of the metal-ligand complex of formula (I) are each independently chosen from (C₁-C₄₀)hydrocarbyl, (C₁-C₄₀)heterohydrocarbyl, Si(R^{C})₃, P(R^{P})₂, N(R^{N})₂, OR^{C}, SR^{C}, NO₂, CN, CF₃, R^{C}S(O)—, R^{C}S(O)₂—, (R^{C})₂C═N—, R^{C}C(O)O—, R^{C}OC(O)—, R^{C}C(O)N(R^{N})—, (R^{N})₂NC(O)—, halogen, hydrogen (—H), or combinations thereof. Independently each R^{C}, R^{P}, and R^{N} are unsubstituted (C₁-C₁₈)hydrocarbyl, (C₁-C₃₀)heterohydrocarbyl, or —H.

The groups R¹ and R¹⁶ in the metal-ligand complex of formula (I) are chosen independently of one another. For example, R¹ may be chosen from a radical having formula (II), (III), or (IV) and R¹⁶ may be a (C₁-C₄₀)hydrocarbyl; or R¹ may be chosen from a radical having formula (II), (III), or (IV) and R¹⁶ may be chosen from a radical having formula (II), (III), or (IV) the same as or different from that of R¹. Both R¹ and R¹⁶ may be radicals having formula (II), for which the groups R³¹⁻³⁵ are the same or different in R¹ and R¹⁶. In other examples, both R¹ and R¹⁶ may be radicals having formula (III), for which the groups R⁴¹⁻⁴⁸ are the same or different in R¹ and R¹⁶; or both R¹ and R¹⁶ may be radicals having formula (IV), for which the groups R⁵¹⁻⁵⁹ are the same or different in R¹ and R¹⁶.

In some embodiments, at least one of R¹ and R¹⁶ is a radical having formula (II), where R³² and R³⁴ are tert-butyl. In one or more embodiments, R³² and R³⁴ are (C₁-C₁₆)hydrocarbyl, —Si[(C₁-C₁₆)hydrocarbyl]₃.

In some embodiments, when at least one of R¹ or R¹⁶ is a radical having formula (III), one of or both of R⁴³ and R⁴⁶ is tert-butyl and R⁴¹⁻⁴², R⁴⁴⁻⁴⁵, and R⁴⁷⁻⁴⁸ are —H. In other embodiments, one of or both of R⁴² and R⁴⁷ is tert-butyl and R⁴¹, R⁴³⁻⁴⁶, and R⁴⁸ are —H. In some embodiments, both R⁴² and R⁴⁷ are —H. In various embodiments, R⁴² and R⁴⁷ are (C₁-C₂₀)hydrocarbyl or —Si[(C₁-C₁₆)hydrocarbyl]₃. In other embodiments, R⁴³ and R⁴⁶ are (C₁-C₂₀)hydrocarbyl or —Si(C₁-C₁₆)alkyl]₃. In some embodiments, R⁴² and R⁴³ are linked to form a cyclic structure, and R⁴⁶ and R⁴⁷ are linked to form a cyclic structure.

In embodiments, when at least one of R¹ or R¹⁶ is a radical having formula (IV), each R⁵², R⁵³, R⁵⁵, R⁵⁷, and R⁵⁸ are —H, (C₁-C₂₀)hydrocarbyl, —Si[(C₁-C₂₀)hydrocarbyl]₃, or —Ge[(C₁-C₂₀)hydrocarbyl]₃. In some embodiments, at least one of R⁵², R⁵³, R⁵⁵, R⁵⁷, and R⁵⁸ is (C₃-C₁₀)alkyl, —Si[(C₃-C₁₀)alkyl]₃, or —Ge[(C₃-C₁₀)alkyl]₃. In one or more embodiments, at least two of R⁵², R⁵³, R⁵⁵, R⁵⁷, and R⁵⁸ is a (C₃-C₁₀)alkyl, —Si[(C₃-C₁₀)alkyl]₃, or —Ge[(C₃-C₁₀)alkyl]₃. In various embodiments, at least three of R⁵², R⁵³, R⁵⁵, R⁵⁷, and R⁵⁸ is a (C₃-C₁₀)alkyl, —Si[(C₃-C₁₀)alkyl]₃, or —Ge[(C₃-C₁₀)alkyl]₃.

In some embodiments, when at least one of R¹ or R¹⁶ is a radical having formula (IV), at least two of R⁵², R⁵³, R⁵⁵, R⁵⁷, and R⁵⁸ are (C₁-C₂₀)hydrocarbyl or —C(H)₂Si[(C₁-C₂₀)hydrocarbyl]₃.

Examples of (C₃-C₁₀)alkyl include, but are not limited to: propyl, 2-propyl (also called iso-propyl), 1,1-dimethylethyl (also called tert-butyl), cyclopentyl, cyclohexyl, 1-butyl, pentyl, 3-methylbutyl, hexyl, 4-methylpentyl, heptyl, n-octyl, tert-octyl (also called 2,4,4-trimethylpentan-2-yl), nonyl, and decyl.

In some embodiment of the metal-ligand catalyst according to formula (I), R¹ and R¹⁶ are chosen from 3,5-di-tert-butylphenyl; 2,4,6-trimethylphenyl; 2,4,6-triisopropylphenyl; 3,5-diisopropylphenyl; carbazolyl; carbazol-9-yl, 1,2,3,4-tetrahydrocarbazolyl; 1,2,3,4,5,6,7,8-octahydrocarbazolyl; 3,6-bis-(3,5-di-tert-butylphenyl)carbazol-9-yl; 3,6-bis-(2,4,6-trimethylphenyl)carbazol-9-yl); 3,6-bis-(2,4,6-triisopropylphenyl)carbazol-9-yl; 2,7-di(tertiarybutyl)-carbazol-9-yl; 2,7-di(tertiary-octyl)-carbazol-9-yl; 2,7-diphenylcarbazol-9-yl; 2,7-bis(2,4,6-trimethylphenyl)-carbazol-9-yl anthracenyl; 2,7-di(triisobutylsilyl)-carbazol-9-yl; 2,7-di(dimethylphenylsilyl)-carbazol-9-yl; 2,7-di(methyldiphenylsilyl)-carbazol-9-yl; 2,7-di(diisopropyl-n-octylsilyl)-carbazol-9-yl; 1,2,3,4-tetrahydroanthracenyl; 1,2,3,4,5,6,7,8-octahydroanthracenyl; phenanthrenyl; 1,2,3,4,5,6,7,8-octahydrophenanthrenyl; 1,2,3,4-tetrahydronaphthyl; 2,6-dimethylphenyl; 2,6-diisopropylphenyl; 3,5-diphenylphenyl; 1-naphthyl; 2-methyl-1-naphthyl; 2-naphthyl; 1,2,3,4-tetra-hydronaphth-5-yl; 1,2,3,4-tetrahydronaphth-6-yl; anthracen-9-yl; 1,2,3,4-tetrahydroanthracen-9-yl; 1,2,3,4,5,6,7,8-octahydroanthracen-9-yl; 1,2,3,4,5,6,7,8-octahydrophenanthren-9-yl; indolyl; indolinyl; quinolinyl; 1,2,3,4-tetrahydroquinolinyl; isoquinolinyl; or 1,2,3,4-tetrahydroisoquinolinyl.

In formula (I), R², R³, R⁴, R⁵, R⁶, R⁷, R⁸, R⁹, R¹⁰, R¹¹, R¹², R¹³, R¹⁴, and R¹⁵ is independently selected from —H, (C₁-C₄₀)hydrocarbyl, (C₁-C₄₀)heterohydrocarbyl, —Si(R^{C})₃, —Ge(R^{C})₃, —P(R^{P})₂, —N(R^{N})₂, —OR^{C}, —SR^{C}, —NO₂, —CN, —CF₃, R^{C}S(O)—, R^{C}S(O)₂—, (R^{C})₂C═N—, R^{C}C(O)O—, R^{C}OC(O)—, R^{C}C(O)N(R)—, (R^{C})₂NC(O)—, and halogen.

In one or more embodiments, R², R⁴, R⁵, R¹², R¹³, and R¹⁵ are hydrogen; and each Z is oxygen.

In embodiments, the dotted lines are optionally dative bonds between the metal center, M, and the group Z. In some embodiments, one of the dotted lines connecting Z and M is dative and the other dotted line does not form a dative bond between Z and M. In various embodiments, both dotted lines form dative bonds between group Z and M.

In various embodiments, R³ and R¹⁴ are (C₁-C₂₄)alkyl. In one or more embodiments, R³ and R¹⁴ are (C₄-C₂₄)alkyl. In some embodiments, R³ and R¹⁴ are 1-propyl, 2-propyl (also called iso-propyl), 1,1-dimethylethyl (also called tert-butyl), cyclopentyl, cyclohexyl, 1-butyl, pentyl, 3-methyl-1-butyl, hexyl, 4-methyl-1-pentyl, heptyl, n-octyl, tert-octyl (also called 2,4,4-trimethylpentan-2-yl), nonyl, and decyl. In embodiments, R³ and R¹⁴ are —OR^{C}, wherein R^{C} is (C₁-C₂₀)hydrocarbon, and in some embodiments, R^{C} is methyl, ethyl, 1-propyl, 2-propyl (also called iso-propyl), or 1,1-dimethylethyl.

In one or more embodiments, one of R⁸ and R⁹ is not —H. In various embodiments, at least one of R⁸ and R⁹ is (C₁-C₂₄)alkyl. In some embodiments, both R⁸ and R⁹ are (C₁-C₂₄)alkyl. In some embodiments, R⁸ and R⁹ are methyl. In other embodiments, R⁸ and R⁹ are halogen.

In some embodiments, R³ and R¹⁴ are methyl; In one or more embodiments, R³ and R¹⁴ are (C₄-C₂₄)alkyl. In some embodiments, R⁸ and R⁹ are 1-propyl, 2-propyl (also called iso-propyl), 1,1-dimethylethyl (also called tert-butyl), cyclopentyl, cyclohexyl, 1-butyl, pentyl, 3-methyl-1-butyl, hexyl, 4-methyl-1-pentyl, heptyl, n-octyl, tert-octyl (also called 2,4,4-trimethylpentan-2-yl), nonyl, and decyl.

In various embodiments, in the metal-ligand complex of formula (I), R⁶ and R¹¹ are halogen. In some embodiments, R⁶ and R¹¹ are (C₁-C₂₄)alkyl. In various embodiments, R⁶ and R¹¹ independently are chosen from methyl, ethyl, 1-propyl, 2-propyl (also called iso-propyl), 1,1-dimethylethyl (also called tert-butyl), cyclopentyl, cyclohexyl, 1-butyl, pentyl, 3-methylbutyl, hexyl, 4-methylpentyl, heptyl, n-octyl, tert-octyl (also called 2,4,4-trimethylpentan-2-yl), nonyl, and decyl. In some embodiments, R⁶ and R¹¹ are tert-butyl. In embodiments, R⁶ and R¹¹ are —OR^{C}, wherein R^{C} is (C₁-C₂₀)hydrocarbyl, and in some embodiments, R^{C} is methyl, ethyl, 1-propyl, 2-propyl (also called iso-propyl), or 1,1-dimethylethyl. In other embodiments, R⁶ and R¹¹ are —SiR^{C}₃, wherein each R^{C} is independently (C₁-C₂₀)hydrocarbyl, and in some embodiments, R^{C} is methyl, ethyl, 1-propyl, 2-propyl (also called iso-propyl), or 1,1-dimethylethyl.

In some embodiments, any or all of the chemical groups (e.g., X and R¹⁻⁵⁹) of the metal-ligand complex of formula (I) may be unsubstituted. In other embodiments, none, any, or all of the chemical groups X and R¹⁻⁵⁹ of the metal-ligand complex of formula (I) may be substituted with one or more than one R^{S}. When two or more than two R^{S} are bonded to a same chemical group of the metal-ligand complex of formula (I), the individual R^{S} of the chemical group may be bonded to the same carbon atom or heteroatom or to different carbon atoms or heteroatoms. In some embodiments, none, any, or all of the chemical groups X and R¹⁻⁵⁹ may be persubstituted with R^{S}. In the chemical groups that are persubstituted with R^{S}, the individual R^{S} may all be the same or may be independently chosen. In one or more embodiments, R^{S} is chosen from (C₁-C₂₀)hydrocarbyl, (C₁-C₂₀)alkyl, (C₁-C₂₀)heterohydrocarbyl, or (C₁-C₂₀)heteroalkyl.

In formula (I), L is (C₁-C₄₀)hydrocarbylene or (C₁-C₄₀)heterohydrocarbylene; and each Z is independently chosen from —O—, —S—, —N(R^{N})—, or —P(R^{P})—. In one or more embodiments, L includes from 1 to 10 atoms.

In formulas (I), (II), (III), and (IV), each R^{C}, R^{P}, and R^{N} is independently a (C₁-C₃₀)hydrocarbyl, (C₁-C₃₀)heterohydrocarbyl, or —H.

In some embodiments of formula (I), the L may be chosen from (C₃-C₇)alkyl 1,3-diradicals, such as —CH₂CH₂CH₂—, —CH(CH₃)CH₂C*H(CH₃), —CH(CH₃)CH(CH₃)C*H(CH₃), —CH₂C(CH₃)₂CH₂—, cyclopentan-1,3-diyl, or cyclohexan-1,3-diyl, for example. In some embodiments, the L may be chosen from (C₄-C₁₀)alkyl 1,4-diradicals, such as —CH₂CH₂CH₂CH₂—, —CH₂C(CH₃)₂C(CH₃)₂CH₂—, cyclohexane-1,2-diyldimethyl, and bicyclo[2.2.2]octane-2,3-diyldimethyl, for example. In some embodiments, L may be chosen from (C₅-C₁₂)alkyl 1,5-diradicals, such as —CH₂CH₂CH₂CH₂CH₂—, and 1,3-bis(methylene)cyclohexane. In some embodiments, L may be chosen from (C₆-C₁₄)alkyl 1,6-diradicals, such as —CH₂CH₂CH₂CH₂CH₂CH₂— or 1,2-bis(ethylene)cyclohexane, for example.

In one or more embodiments, L is (C₂-C₄₀)heterohydrocarbylene, and at least one of the from 2 to 10 atoms includes a heteroatom. In some embodiments, L is —CH₂Ge(R^{C})₂CH₂—, where each R^{C} is (C₁-C₃₀)hydrocarbyl. In some embodiments, L is —CH₂Ge(CH₃)₂CH₂—, —CH₂Ge(ethyl)₂CH₂—, —CH₂Ge(2-propyl)₂CH₂—, —CH₂Ge(t-butyl)₂CH₂—, —CH₂Ge(cyclopentyl)₂CH₂—, or —CH₂Ge(cyclohexyl)₂CH₂—.

In one or more embodiments, L is chosen from —CH₂—; —CH₂CH₂—; —CH₂(CH₂)ₘCH₂—, where m is from 1 to 3; —CH₂Si(R^{C})₂CH₂—; —CH(CH₃)CH₂CH*(CH₃), where C* denotes the placement of the radical (the group may also be written as: —CH(CH₃)CH₂CH(CH₃)—); and —CH₂(phen-1,2-di-yl)CH₂—; where each R^{C} in L is (C₁-C₂₀)hydrocarbyl.

Examples of such (C₁-C₁₂)alkyl include, but are not limited to methyl, ethyl, 1-propyl, 2-propyl (also called iso-propyl), 1,1-dimethylethyl, cyclopentyl, or cyclohexyl, butyl, tert-butyl, pentyl, hexyl, heptyl, n-octyl, tert-octyl (also called 2,4,4-trimethylpent-2-yl), nonyl, decyl, undecyl, and dodecyl.

In some embodiments, in the metal-ligand complex according to formula (I), both R⁸ and R⁹ are methyl. In other embodiments, one of R⁸ and R⁹ is methyl and the other of R⁸ and R⁹ is —H.

In the metal-ligand complex according to formula (I), X bonds with M through a covalent bond or an ionic bond. In some embodiments, X may be a monoanionic ligand having a net formal oxidation state of −1. Each monoanionic ligand may independently be hydride, (C₁-C₄₀)hydrocarbyl carbanion, (C₁-C₄₀)heterohydrocarbyl carbanion, halide, nitrate, carbonate, phosphate, sulfate, HC(O)O—, HC(O)N(H)—, (C₁-C₄₀)hydrocarbylC(O)O⁻, (C₁-C₄₀)hydrocarbylC(O)N((C₁-C₂₀)hydrocarbyl)-, (C₁-C₄₀)hydrocarbylC(O)N(H)⁻, R^{K}R^{L}B⁻, R^{K}R^{L}N⁻, R^{K}O⁻, R^{K}S⁻, R^{K}R^{L}P⁻, or R^{M}R^{K}R^{L}Si⁻, where each R^{K}, R^{L}, and R^{M} independently is hydrogen, (C₁-C₄₀)hydrocarbyl, or (C₁-C₄₀)heterohydrocarbyl, or R^{K} and R^{L} are taken together to form a (C₂-C₄₀)hydrocarbylene or (C₁-C₂₀)heterohydrocarbylene and R^{M} is as defined above.

In some embodiments, X is unsubstituted (C₁-C₂₀)hydrocarbyl, unsubstituted (C₁-C₂₀)hydrocarbylC(O)O—, or R^{K}R^{L}N—, wherein each of R^{K} and R^{L} independently is an unsubstituted(C₁-C₂₀)hydrocarbyl. In some embodiments, each monodentate ligand X is a chlorine atom, (C₁-C₁₀)hydrocarbyl (e.g., (C₁-C₆)alkyl or benzyl), unsubstituted (C₁-C₁₀)hydrocarbylC(O)O—, or R^{K}R^{L}N—, wherein each of R^{K} and R^{L} independently is an unsubstituted (C₁-C₁₀)hydrocarbyl.

In some embodiments, n is 1, and X and T are linked and selected from the group consisting of:

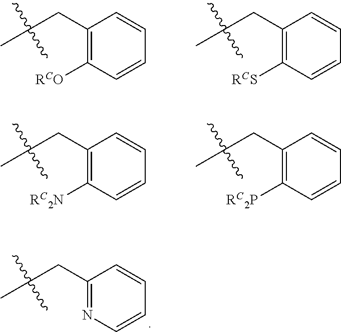

In further embodiments, X is selected from methyl; ethyl; 1-propyl; 2-propyl; 1-butyl; 2,2-dimethylpropyl; trimethylsilylmethyl; phenyl; benzyl; or chloro. In one embodiment, k is 2. In a specific embodiment, when k is 2 the two X groups are linked to form a bidentate ligand.

In one or more embodiments, each X is independently —(CH₂)SiR^{X}₃, in which each R^{X} is independently a (C₁-C₃₀)alkyl or a (C₁-C₃₀)heteroalkyl and at least one R^{X} is (C₁-C₃₀)alkyl. In some embodiments, when one of R^{X} is a (C₁-C₃₀)heteroalkyl, the heteroatom is silica or oxygen atom. In some embodiments, R^{X} is methyl, ethyl, propyl, 2-propyl, butyl, 1,1-dimethylethyl (or tert-butyl), pentyl, hexyl, heptyl, n-octyl, tert-octyl, or nonyl.

In one or more embodiments X is —(CH₂)Si(CH₃)₃, —(CH₂)Si(CH₃)₂(CH₂CH₃); —(CH₂)Si(CH₃)(CH₂CH₃)₂, —(CH₂)Si(CH₂CH₃)₃, —(CH₂)Si(CH₃)₂(n-butyl), —(CH₂)Si(CH₃)₂(n-hexyl), —(CH₂)Si(CH₃)(n-Oct)R^{X}, —(CH₂)Si(n-Oct)R^{X}₂, —(CH₂)Si(CH₃)₂(2-ethylhexyl), —(CH₂)Si(CH₃)₂(dodecyl), —CH₂Si(CH₃)₂CH₂Si(CH₃)₃(herein referred to as —CH₂Si(CH₃)₂CH₂TMS). Optionally, in some embodiments, the metal-ligand complex according to formula (I), exactly two R^{X} are covalently linked or exactly three R^{X} are covalently linked.

In some embodiments, X is —CH₂Si(R^{C})_{3-Q}(OR^{C})_{Q}, —Si(R^{C})_{3-Q}(OR^{C})_{Q}, —OSi(R^{C})_{3-Q}(OR^{C})_{Q}, in which subscript Q is 0, 1, 2 or 3 and each R^{C} is independently a substituted or unsubstituted (C₁-C₃₀)hydrocarbyl, or a substituted or unsubstituted (C₁-C₃₀)heterohydrocarbyl.

In some embodiments, X is B(R^{Y})₄, Al(R^{Y})₄, or Ga(R^{Y})₄, wherein each R^{Y} is —H, (C₁-C₃₀)hydrocarbyl. In a specific embodiment, when k is 2 the two X groups are linked to form a bidentate ligand such that two of R are both independently connected to the metal M.

In the metal-ligand complex according to formula (I), each T bonds with M through a a dative bond or an ionic bond. In one or more embodiments, T is a Lewis base. The Lewis base may be a compound or an ionic species, which can donate an electron pair to an acceptor compound. For purposes of this description, the acceptor compound is M, the metal of the metal-ligand complex of formula (I). The Lewis base may be neutral or anionic. In some embodiments, the Lewis base may be a heterohydrocarbon or a hydrocarbon. Examples of neutral heterohydrocarbon lewis bases includes, but are not limited to, amines, trialkylamines, ethers, cycloethers, or sulfides. An example of anionic hydrocarbon includes, but is not limited to, cyclopentadiene. An example of a neutral hydrocarbon includes, but is not limited to, 1,3-buta-di-ene.

In one or more embodiments, the Lewis base may be a monodentate ligand that may a neutral ligand. In some embodiments, the neutral ligand may contain a heteroatom. In specific embodiments, the neutral ligand is a neutral group such as R^{T}NR^{K}R^{L}, R^{K}OR^{L}, R^{K}SR^{L}, or R^{T}PR^{K}R^{L}, where each R^{T} independently is hydrogen, [(C₁-C₁₀)hydrocarbyl]₃Si(C₁-C₁₀)hydrocarbyl, (C₁-C₄₀)hydrocarbyl, [(C₁-C₁₀)hydrocarbyl]₃Si, or (C₁-C₄₀)heterohydrocarbyl and each R^{K} and R^{L} independently is as previously defined.

In some embodiments, the Lewis base is (C₁-C₂₀)hydrocarbon. In some embodiments, the Lewis base is cyclopentadiene or 1,3-buta-di-ene.

In various embodiments, the Lewis base is (C₁-C₂₀)heterohydrocarbon, wherein the hetero atom of the heterohydrocarbon is oxygen. In some embodiments, T is tetrahydrofuran, diethyl ether, or methyl tert-butyl ether (MTBE).

In the metal-ligand complex of formula (I), each Z independently is O, S, N(C₁-C₄₀)hydrocarbyl, or P(C₁-C₄₀)hydrocarbyl. In some embodiments, each Z is different. For example, one Z is O and the other Z is NCH₃. In some embodiments, one Z is O and one Z is S. In another embodiment, one Z is S and one Z is N(C₁-C₄₀)hydrocarbyl, (for example, NCH₃). In a further embodiment, each Z is the same. In yet another embodiment, each Z is O. In another embodiment, each Z is S.

In formula (I), each Z is connected to M via a dotted line. The dotted line defines an optional dative bond. In some embodiments, one of the dotted lines forms a dative bond between Z and M and the second dotted line is not directly connected or bonded Z to M. In various embodiments, each Z forms a dative bond with M. In other embodiments, each Z is not directly connected or bonded to M. Without intent to be bond by theory, it is believed that number of Z-M dative bonds depends on the atomic radius of the metal as defined by M.

In specific embodiments of catalyst systems, the metal-ligand complex according to formula (I) may include, without limitation, a complex having the structure of any of Metal-Ligand Complexes 1-3 (US 2021/015723):

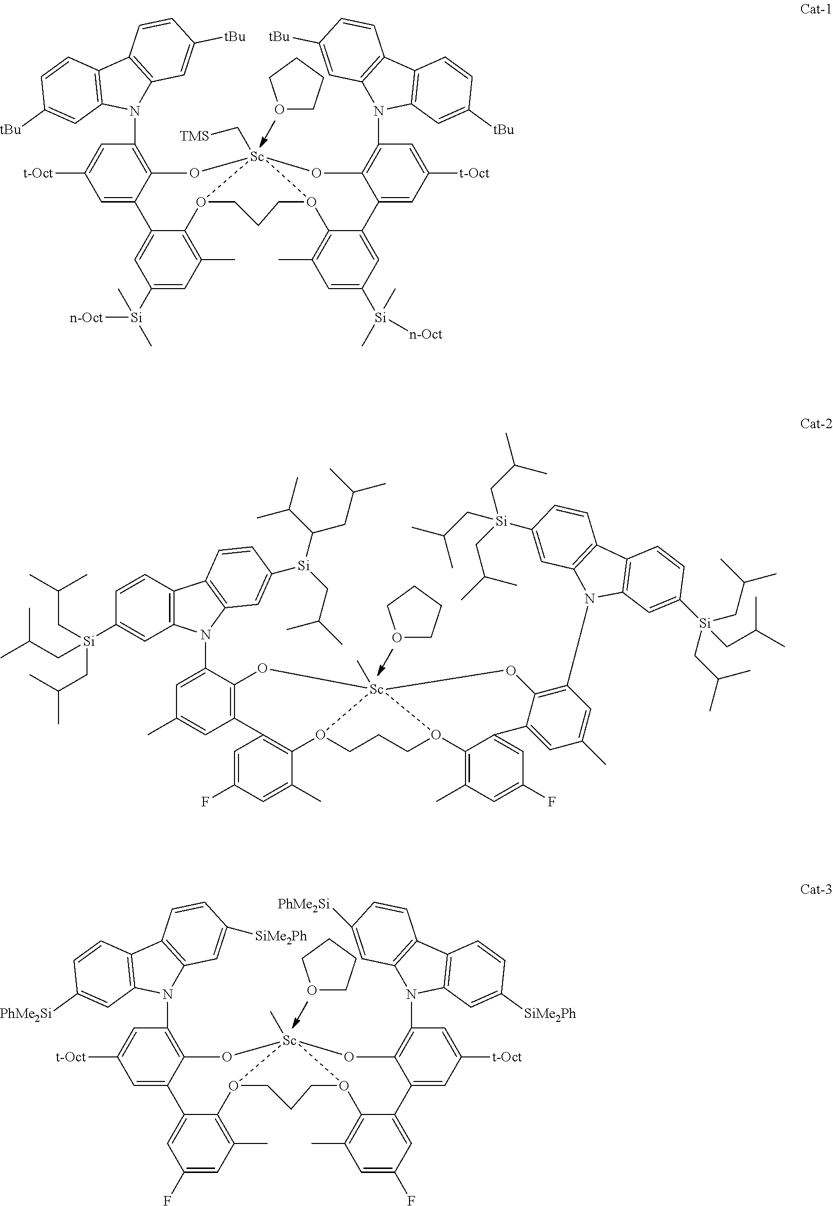

### Olefin Propagation

While a co-catalyst is not required to initiate olefin propagation on the metal-ligand complex of formula (I), it is believed that the metal-ligand complex is not efficient when the Lewis base, T, is coordinated to the metal center, M, of formula (I). Therefore, without intent to be bound by theory, it is believed that during olefin propagation, the Lewis base disassociates from the metal center, M, and the metal-ligand complex has a structure according to formula (Ia):

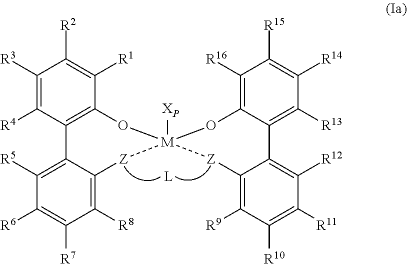

In formula (Ia), R¹ through R¹⁶, M, Z, and L are as defined in formula (I). X_{P} is hydrocarbyl, where the hydrocarbyl is branched or unbranched having at least 30 carbon atoms. More specifically, X_{P} is the propagating olefin chain.

### Additive Component

An additive is a chemical agent present during the polymerization reaction the does not deter olefin propagation. In one or more embodiments, the catalyst system further comprises an additive. In some embodiments, the additives function as a co-catalyst. In other embodiments, the additives function as a scavenger or scavenging agent. In some embodiments, the additives function as an alkylating agent. In one or more embodiments, the additives may have more than one function or may function as a scavenger, alkylating agent and co-catalyst.

A co-catalyst is a reagent that reacts with a procatalyst to form an active catalyst. Without intent to be bound by theory, it is believed the Lewis Base, T, of formula (I), disassociates without the presence of a co-catalyst. However, it is also believed that a co-catalyst may promote the disassociation of the Lewis base and the metal center of the metal-ligand complex.

Suitable additives may include, but are not limited to, alkyl aluminums; polymeric or oligomeric alumoxanes (also known as aluminoxanes); neutral Lewis acids; and non-polymeric, non-coordinating, ion-forming compounds (including the use of such compounds under oxidizing conditions). Combinations of one or more of the foregoing additives and techniques are also contemplated. The term “alkyl aluminum” means a monoalkyl aluminum dihydride or monoalkylaluminum dihalide, a dialkyl aluminum hydride or dialkyl aluminum halide, or a trialkylaluminum. Examples of polymeric or oligomeric alumoxanes include methylalumoxane, triisobutylaluminum-modified methylalumoxane, and isobutylalumoxane.

In some embodiments, the additive is a Lewis acid Group 13 metal compounds containing (C₁-C₂₀)hydrocarbyl substituents as described herein. In some embodiments, the additives include tri((C₁-C₂₀)hydrocarbyl)-substituted-aluminum or tri((C₁-C₂₀)hydrocarbyl)-boron compounds. In other embodiments, the additives are chosen from tri(hydrocarbyl)-substituted-aluminum, tri((C₁-C₂₀)hydrocarbyl)-boron compounds, tri((C₁-C₁₀)alkyl)aluminum, tri((C₆-C₁₈)aryl)boron compounds, and halogenated (including perhalogenated) derivatives thereof.

In one or more embodiments, the polymerization process further includes a borate-based additive. In some embodiments, the borate-based additive is selected from tris(fluoro-substituted phenyl)boranes, tris(pentafluorophenyl)borane. In some embodiments, the co-catalyst is a tri((C₁-C₂₀)hydrocarbyl)ammonium tetra((C₁-C₂₀)hydrocarbyl)borate (e.g. bis(octadecyl)methylammonium tetrakis(pentafluorophenyl)borate). As used herein, the term “ammonium” means a nitrogen cation that is a ((C₁-C₂₀)hydrocarbyl)₄N⁺ a ((C₁-C₂₀)hydrocarbyl)₃N(H)⁺, a ((C₁-C₂₀)hydrocarbyl)₂N(H)₂⁺, (C₁-C₂₀)hydrocarbylN(H)₃⁺, or N(H)₄⁺, wherein each (C₁-C₂₀)hydrocarbyl, when two or more are present, may be the same or different.

In one or more embodiments, the additive may be chosen from polymeric or oligomeric aluminoxanes, especially methyl aluminoxane, as well as inert, compatible, noncoordinating, ion forming compounds. Exemplary suitable additives include, but are not limited to modified methyl aluminoxane (MMAO), bis(hydrogenated tallow alkyl)methyl, tetrakis(pentafluorophenyl)borate(1-)ammonium, triethyl aluminum, butylatedhydroxy-toluene diethyl aluminum, bis-(butylatedhydroxy-toluene) ethyl aluminum, tris-(butylatedhydroxy-toluene) aluminum and combinations thereof.

Additives, such as aluminoxanes and alkyl aluminums, may have multiple functions. aluminoxanes and alkyl aluminums may function as co-catalyst, scavengers, and alkylating agents in the polymerization process.

In some embodiments, the additive is a alkyl aluminum having a formula of AlR^{A1}R^{B1}R^{C1}, where R^{A1}, R^{B1}, and R^{C1} are independently (C₁-C₄₀)alkyl. In one or more embodiments, R^{A1}, R^{B1}, and R^{C1} are independently (C₁-C₁₀)alkyl. In one or more embodiments, R^{A1}, R^{B1}, and R^{C1} are independently methyl, ethyl, propyl, 2-propyl, butyl, tert-butyl, or octyl. In some embodiment, R^{A1}, R^{B1}, and R^{C1} are the same. In other embodiments, at least one of R^{A1}, R^{B1}, and R^{C1} is different from the other R^{A1}, R^{B1} and R^{C1}.

In some embodiments, the aluminum alkyl species is triisobutylaluminum (TiBAl) or aluminoxanes. The alkylaluminoxane may be a polymeric form of a (C₁-C₁₀)alkylaluminoxane or a polymethylaluminoxane (PMAO). The PMAO may be a polymethylaluminoxane-Improved Performance (PMAO-IP), which is commercially available from Nouryon. The (C₁-C₁₀)alkylaluminoxane may be methylaluminoxane (MAO), a modified methylaluminoxane (MMAO) such as modified methylaluminoxane, type 3A (MMAO-3A), type 7 (MMAO-7), or type 12 (MMAO-12), ethylaluminoxane, n-propylaluminoxane, isopropylaluminoxane, butylaluminoxane, isobutylaluminoxane, n-pentylaluminoxane, neopentylaluminoxane, n-hexylaluminoxane, n-octylaluminoxane, 2-ethylhexylaluminoxane, cyclohexylaluminoxane, or 1-methylcyclopentylaluminoxane. The arylaluminoxane may be a (C₆-C₁₀)arylaluminoxane, which may be phenylaluminoxane, 2,6-dimethylphenylaluminoxane, or naphthylaluminoxane.

In some embodiments, one or more co-catalysts may be used in combination with each other. A specific example of a co-catalyst combination is a mixture of a tri((C₁-C₈)hydrocarbyl)aluminum, tri((C₁-C₄)hydrocarbyl)borane, tri((C₆-C₁₈)aryl)borane or an ammonium borate with an oligomeric or polymeric alumoxane compound. The ratio of total number of moles of one or more metal-ligand complexes of formula (I) to total number of moles of one or more of the co-catalysts is from 1:10,000 to 100:1. In some embodiments, the ratio is at least 1:5000, in some other embodiments, at least 1:1000; and 10:1 or less, and in some other embodiments, 1:1 or less. When an alumoxane alone is used as the co-catalyst, preferably the ratio Al of the alumoxane and metal of the metal ligand complex of formula (I) (Al/M) is at least 20. When tris(pentafluorophenyl)borane alone is used as the co-catalyst, in some other embodiments, the number of moles of the tris(pentafluorophenyl)borane that are employed to the total number of moles of one or more metal-ligand complexes of formula (I) from 0.5:1 to 10:1, from 1:1 to 6:1, or from 1:1 to 5:1.

### Catalyst System Components

In embodiments, the second catalyst system includes at least one group IV catalyst. The at least one group IV catalyst may be chosen from a Group IV metal-ligand complex such as a titanium (Ti) metal-ligand complex, a zirconium (Zr) metal-ligand complex, or a hafnium (Hf) metal-ligand complex. In one or more embodiments, the Group IV metal-ligand complex includes a bis-biphenylphenoxy Group IV metal-ligand complex, a procatalyst, which may be rendered catalytically active upon contact with the activators of this disclosure.

In one or more embodiments, the Group IV metal-ligand complex may include a -biphenylphenoxy Group IV metal-ligand complex, a constrained geometry catalyst, or a phosphinimide Group IV complex.

According to some embodiments, the bis-biphenylphenoxy Group IV metal-ligand complex has a structure according to formula (X):

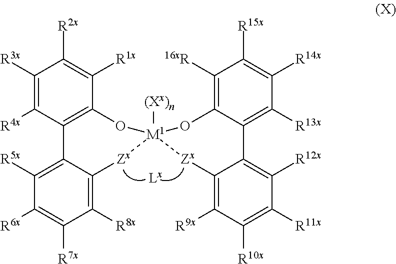

In formula (X), M¹ is a metal chosen from titanium, zirconium, or hafnium, the metal being in a formal oxidation state of +2, +3, or +4. Subscript n of (X^{x})ₙ is 1, 2, or 3. When subscript n is 1, X^{x} is a monodentate ligand or a bidentate ligand, and when subscript n is 2, each X is a monodentate ligand. In formula (X), each Z is independently chosen from —O—, —S—, —N(R^{N}), or —P(R^{P})—; L^{x} is (C₁-C₄₀)hydrocarbylene or (C₁-C₄₀)heterohydrocarbylene R^{2x-4x}, R^{5x-8x}, R^{9x-12x} and R^{13x-15x} are independently selected from the group consisting of —H, (C₁-C₄₀)hydrocarbyl, (C₁-C₄₀)heterohydrocarbyl, —Si(R^{C})₃, —Ge(R^{C})₃, —P(R^{P})₂, —N(R^{N})₂, —OR^{C}, SR^{C}, NO₂, —CN, —CF₃, R^{C}S(O)—, R^{C}S(O)₂—, —N═C(R^{C})₂, R^{C}C(O)O—, R^{C}OC(O)—, R^{C}C(O)N(R)—, (R^{C})₂NC(O)—, and halogen. R^{1x} and R^{16x} are selected from radicals having formula (XI), radicals having formula (XII), and radicals having formula (XIII):

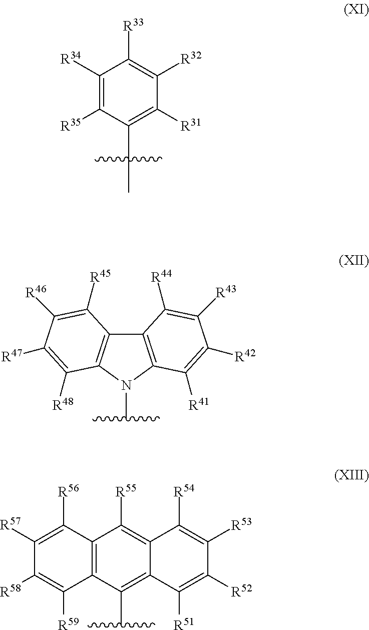

In formulas (XI), (XII), and (XIII), each of R³¹⁻³⁵, R⁴¹⁻⁴⁸, and R⁵¹⁻⁵⁹ is independently chosen from —H, (C₁-C₄₀)hydrocarbyl, (C₁-C₄₀)heterohydrocarbyl, —Si(R^{C})₃, —Ge(R^{C})₃, —P(R^{P})₂, —N(R^{N})₂, —OR^{C}, —SR^{C}, —NO₂, —CN, —CF₃, R^{C}S(O)—, R^{C}S(O)₂—, (R^{C})₂C═N—, R^{C}C(O)O—, R^{C}OC(O)—, R^{C}C(O)N(R^{N})—, (R^{C})₂NC(O)—, or halogen.

In some embodiments of formula (X), the L^{x} may be chosen from (C₃-C₇)alkyl 1,3-diradicals, such as —CH₂CH₂CH₂—, —CH(CH₃)CH₂C*H(CH₃), —CH(CH₃)CH(CH₃)C*H(CH₃), —CH₂C(CH₃)₂CH₂—, cyclopentan-1,3-diyl, or cyclohexan-1,3-diyl, for example. In some embodiments, the L^{x} may be chosen from (C₄-C₁₀)alkyl 1,4-diradicals, such as —CH₂CH₂CH₂CH₂—, —CH₂C(CH₃)₂C(CH₃)₂CH₂—, cyclohexane-1,2-diyldimethyl, and bicyclo[2.2.2]octane-2,3-diyldimethyl, for example. In some embodiments, L may be chosen from (C₅-C₁₂)alkyl 1,5-diradicals, such as —CH₂CH₂CH₂CH₂CH₂—, and 1,3-bis(methylene)cyclohexane. In some embodiments, L^{x} may be chosen from (C₆-C₁₄)alkyl 1,6-diradicals, such as —CH₂CH₂CH₂CH₂CH₂CH₂— or 1,2-bis(ethylene)cyclohexane, for example.

In one or more embodiments, L is (C₂-C₄₀)heterohydrocarbylene, and at least one of the from 2 to 10 atoms includes a heteroatom. In some embodiments, L is —CH₂Ge(R^{C})₂CH₂—, where each R^{C} is (C₁-C₃₀)hydrocarbyl. In some embodiments, L is —CH₂Ge(CH₃)₂CH₂—, —CH₂Ge(ethyl)₂CH₂—, —CH₂Ge(2-propyl)₂CH₂—, —CH₂Ge(t-butyl)₂CH₂—, —CH₂Ge(cyclopentyl)₂CH₂—, or —CH₂Ge(cyclohexyl)₂CH₂—.

In one or more embodiments, in formula (X), each X^{x} can be a monodentate ligand that, independently from any other ligands X^{x}, is a halogen, unsubstituted (C₁-C₂₀)hydrocarbyl, unsubstituted [(C₁-C₂₀)hydrocarbyl]C(O)O—, or R^{K}R^{L}N—, wherein each of R^{K} and R^{L} independently is an unsubstituted(C₁-C₂₀)hydrocarbyl. In some embodiments, X^{x} is benzyl, phenyl, chloro, (C₁-C₁₀)alkyl, or —CH₂Si(R^{x}), where each R^{x} is (C₁-C₂₀)alkyl.

Illustrative metal-ligand complexes according to formula (X) include, for example:

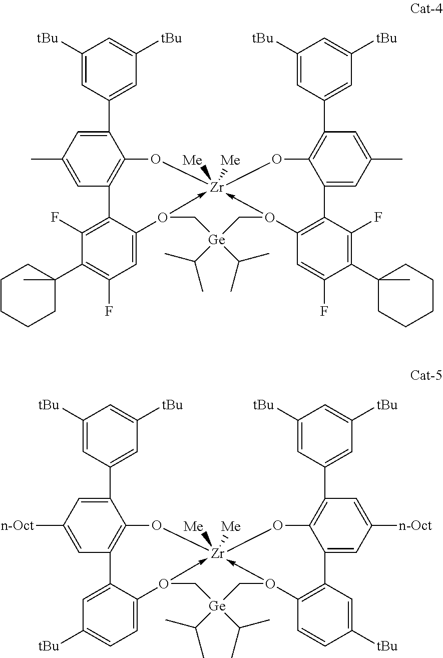

Other bis-biphenylphenoxy Group IV metal-ligand complexes that may be used in combination with an additive in the catalyst systems of this disclosure will be apparent to those skilled in the art.

In one or more embodiments, the Group IV metal-ligand complex includes a constrained-geometry Group IV complex having a structure according to formula (XV):

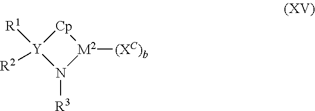

In formula (XV), M² is titanium, hafnium or zirconium. Subscript b of (X)_{b} is 1, 2, or 3. Each X^{C} is a monodentate ligand or bidentate ligand independently chosen from unsaturated (C₂-C₅₀)hydrocarbon, unsaturated (C₂-C₅₀)heterohydrocarbon, saturated (C₂-C₅₀)heterohydrocarbon, (C₁-C₅₀)hydrocarbyl, (C₆-C₅₀)aryl, (C₆-C₅₀)heteroaryl, cyclopentadienyl, substituted cyclopentadienyl, (C₄-C₁₂)diene, halogen, —N(R^{N})₂, and —NCOR^{C}. The metal-ligand complex is overall charge-neutral.

In one or more embodiments, in formula (XV), each X^{C} can be a monodentate ligand that, independently from any other ligands X^{C}, is a halogen, unsubstituted (C₁-C₂₀)hydrocarbyl, unsubstituted [(C₁-C₂₀)hydrocarbyl]C(O)O—, or R^{K}R^{L}N—, wherein each of R^{K} and R^{L} independently is an unsubstituted(C₁-C₂₀)hydrocarbyl. In some embodiments, X^{C} is benzyl, phenyl, chloro, (C₁-C₁₀)alkyl, or —CH₂Si(R^{x}), where each R^{x} is (C₁-C₂₀)alkyl.

In formula (XV), Cp is selected from the group consisting of cyclopentadienyl and R^{S} substituted cyclopentadienyl, the Cp being bound in an η⁵ bonding mode to M, wherein R^{S} is independently selected from the group consisting of (C₁-C₂₀)alkyl, (C₁-C₂₀)heteroalkyl, (C₁-C₂₀)aryl, or R^{S} substituent (C₁-C₂₀)aryl, (C₁-C₂₀)heteroaryl, or R^{S} substituent (C₁-C₂₀)heteroaryl, wherein two adjacent R^{S} groups are optionally linked to form a ring.

In formula (XV), N is nitrogen; Y is carbon or silicon; wherein Y is covalently bonded to Cp; and R¹ and R² are independently selected from —H, (C₁-C₄₀)hydrocarbyl, and (C₁-C₄₀)heterohydrocarbyl; and R³ are independently selected from (C₁-C₄₀)hydrocarbyl, and (C₁-C₄₀)heterohydrocarbyl.

Other catalysts, especially catalysts containing one or more other Group IV metal-complexes not specifically listed above, will be apparent to those skilled in the art.

### Catalyst System Properties

The procatalyst comprising the metal-ligand complex of formula (I) and one or more cocatalysts, as described herein, has a reactivity ratio r₁, as further defined hereinbelow, in the range of greater than 100; for example, greater than 150, greater than 200, greater than 300, or greater than 500.

For random copolymers in which the identity of the last monomer inserted dictates the rate at which subsequent monomers insert, the terminal copolymerization model is employed. In this model insertion reactions of the type

$$… {M}_{i} {C}^{*} + {M}_{j} {⟶}^{{k}_{ij}} … {M}_{i} {M}_{j} {C}^{*} \qquad ( A )$$

where C* represents the catalyst, Mᵢ represents monomer i, and kᵢⱼ is the rate constant having the rate equation

$${R}_{{p}_{ij}} = {k}_{ij} [ … {M}_{i} {C}^{*} ] [ {M}_{j} ] \qquad ( B )$$

The comonomer mole fraction (i=2) in the reaction media is defined by the equation:

$${f}_{2} = \frac{[ {M}_{2} ]}{[ {M}_{1} ] + [ {M}_{2} ]} \qquad ( C )$$

A simplified equation for comonomer composition can be derived as disclosed in George Odian, Principles of Polymerization, Second Edition, John Wiley and Sons, 1970, as follows:

$${F}_{2} = \frac{{{r}_{1} ( 1 - {f}_{2} )}^{2} + ( 1 - {f}_{2} ) {f}_{2}}{{{r}_{1} ( 1 - {f}_{2} )}^{2} + 2 ( 1 - {f}_{2 )} ) {f}_{2} + {r}_{2} {f}_{2}^{2}} \qquad ( D )$$

From this equation the mole fraction of comonomer in the polymer is solely dependent on the mole fraction of comonomer in the reaction media and two temperature dependent reactivity ratios defined in terms of the insertion rate constants as:

$$\begin{matrix}{r}_{1} = \frac{{k}_{11}}{{k}_{12}} & {r}_{2} = \frac{{k}_{22}}{{k}_{21}}\end{matrix} \qquad ( E )$$

Alternatively, in the penultimate copolymerization model, the identities of the last two monomers inserted in the growing polymer chain dictate the rate of subsequent monomer insertion. The polymerization reactions are of the form

$$… {M}_{i} {M}_{j} {C}^{*} + {M}_{k} {⟶}^{{k}_{ijk}} … {M}_{i} {M}_{j} {M}_{k} {C}^{*} \qquad ( G )$$

and the individual rate equations are:

$${R}_{{p}_{{ijk}^{}}} = {k}_{ijk} [ … {M}_{i} {M}_{j} = {C}^{*} ] [ {M}_{k} ] \qquad ( H )$$

The comonomer content can be calculated (again as disclosed in George Odian, Supra.) as:

$$\frac{( 1 - {F}_{2} )}{{F}_{2}} = \frac{1 + \frac{{r}_{1}^{′} X ( {r}_{1} X + 1 )}{( {r}_{1}^{′} X + 1 )}}{1 + \frac{{r}_{2}^{′} ( {r}_{2} + X )}{x ( {r}_{2}^{′} + X )}} \qquad ( I )$$

where X is defined as:

$$X = \frac{( 1 - {f}_{2} )}{{f}_{2}} \qquad ( J )$$

and the reactivity ratios are defined as:

$$\begin{matrix}{r}_{1} = \frac{{k}_{111}}{{k}_{112}} & {r}_{1}^{′} = \frac{{k}_{211}}{{k}_{212}} \\ {r}_{2} = \frac{{k}_{222}}{{k}_{221}} & {r}_{2}^{′} = \frac{{k}_{222}}{{k}_{221}}\end{matrix} \qquad ( K )$$

For this model as well the polymer composition is a function only of temperature dependent reactivity ratios and comonomer mole fraction in the reactor. The same is also true when reverse comonomer or monomer insertion may occur or in the case of the interpolymerization of more than two monomers.

Reactivity ratios for use in the foregoing models may be predicted using well known theoretical techniques or empirically derived from actual polymerization data. Suitable theoretical techniques are disclosed, for example, in B. G. Kyle, Chemical and Process Thermodynamics, Third Addition, Prentice-Hall, 1999 and in Redlich-Kwong-Soave (RKS) Equation of State, Chemical Engineering Science, 1972, pp 1197-1203. Commercially available software programs may be used to assist in deriving reactivity ratios from experimentally derived data. One example of such software is Aspen Plus from Aspen Technology, Inc., Ten Canal Park, Cambridge, MA 02141-2201 USA.

Accordingly, the process for producing ethylene based polymers according to the present invention selectively gives the rich polyethylene (e.g., a high density polyethylene) or rich polyethylene segment of the poly(ethylene alpha-olefin) copolymer in the presence of alpha-olefin, which is substantially unpolymerized thereby. The process for producing ethylene-based polymers employs olefin polymerizing conditions. In some embodiments, the olefin polymerizing conditions independently produce a catalyst in situ that is formed by reaction of the procatalyst comprising metal-ligand complex of formula (I), and one or more cocatalysts in the presence of one or more other ingredients. Such other ingredients include, but are not limited to, (i) olefin monomers; (ii) another metal-ligand complex of formula (I); (iii) one or more of catalyst systems; (iv) one or more chain shuttling agents; (v) one or more catalyst stabilizers; (vi) one or more solvents; and (vii) a mixture of any two or more thereof.

A particularly inventive catalyst is one that can achieve a high selectivity for polymerizing ethylene in the presence of the (C₃-C₄₀) alpha-olefin in the process for producing an ethylene-based polymer, wherein the high selectivity is characterized by the reactivity ratio r₁ described previously. Preferably for the inventive process, the reactivity ratio r₁ is greater than 50, more preferably greater than 100, still more preferably greater than 150, still more preferably greater than 200. When the reactivity ratio r₁ for the invention process approaches infinity, incorporation of the alpha-olefin into (or onto) the rich polyethylene produced thereby approaches 0 mole percent (mol %).

### Polyolefins

The catalytic systems described in this disclosure may be utilized in the polymerization of olefins, primarily ethylene, propylene, α-olefins, such as octene, and dienes. In some embodiments, there is only a single type of olefin or α-olefin in the polymerization scheme, creating a homopolymer. However, additional α-olefins may be incorporated into the polymerization procedure. The additional α-olefin co-monomers typically have no more than 20 carbon atoms. For example, the α-olefin co-monomers may have 3 to 10 carbon atoms or 3 to 8 carbon atoms. Exemplary α-olefin co-monomers include, but are not limited to, propylene, 1-butene, 1-pentene, 1-hexene, 1-heptene, 1-octene, 1-nonene, 1-decene, and 4-methyl-1-pentene. For example, the one or more α-olefin co-monomers may be selected from the group consisting of propylene, 1-butene, 1-hexene, and 1-octene; or in the alternative, from the group consisting of 1-hexene and 1-octene.

The ethylene-based polymers, for example homopolymers and/or interpolymers (including copolymers) of ethylene and optionally one or more co-monomers such as α-olefins, may comprise from at least 50 mole percent (mol %) monomer units derived from ethylene. All individual values and subranges encompassed by “from at least 50 mole percent” are disclosed herein as separate embodiments; for example, the ethylene based polymers, homopolymers and/or interpolymers (including copolymers) of ethylene and optionally one or more co-monomers such as α-olefins may comprise at least 60 mole percent monomer units derived from ethylene; at least 70 mole percent monomer units derived from ethylene; at least 80 mole percent monomer units derived from ethylene; or from 50 to 100 mole percent monomer units derived from ethylene; or from 80 to 100 mole percent monomer units derived from ethylene.

In some embodiments, the catalyst systems may produce ethylene-based polymers that include at least 90 mole percent units derived from ethylene. All individual values and subranges from at least 90 mole percent are included herein and disclosed herein as separate embodiments. For example, the ethylene-based polymers may comprise at least 93 mole percent units derived from ethylene; at least 96 mole percent units; at least 97 mole percent units derived from ethylene; or in the alternative, from 90 to 100 mole percent units derived from ethylene; from 90 to 99.5 mole percent units derived from ethylene; or from 97 to 99.5 mole percent units derived from ethylene.

In some embodiments, the catalyst system produces ethylene-based polymers having an amount of additional α-olefin that is less than 50 mole percent (mol %); other embodiments the amount of additional α-olefin includes at least 0.01 mol % to 25 mol %; and in further embodiments the amount of additional α-olefin includes at least 0.1 mol % to 10 mol %. In some embodiments, the additional α-olefin is 1-octene.

The ethylene-based polymers may be produced by otherwise conventional polymerization processes that incorporate the catalyst systems according to embodiments of this disclosure. Such conventional polymerization processes include, but are not limited to, solution polymerization processes, gas phase polymerization processes, slurry phase polymerization processes, and combinations thereof using one or more conventional reactors such as loop reactors, isothermal reactors, fluidized bed gas phase reactors, stirred tank reactors, batch reactors in parallel, series, or any combinations thereof, for example.

In one embodiment, the ethylene-based polymer may be produced via solution polymerization in a dual reactor system, for example a dual loop reactor system, wherein ethylene and, optionally, one or more α-olefins are polymerized in the presence of the catalyst system, as described herein, and optionally one or more co-catalysts. In another embodiment, the ethylene-based polymer may be produced via solution polymerization in a dual reactor system, for example a dual loop reactor system, wherein ethylene and optionally one or more α-olefins are polymerized in the presence of the catalyst system in this disclosure, and as described herein, and optionally one or more other catalysts. The catalyst systems, as described herein, can be used in the first reactor, or second reactor, optionally in combination with one or more other catalysts. In one embodiment, the ethylene-based polymer may be produced via solution polymerization in a dual reactor system, for example a dual loop reactor system, wherein ethylene and optionally one or more α-olefins are polymerized in the presence of the catalyst system, as described herein, in both reactors.

In another embodiment, the ethylene-based polymer may be produced via solution polymerization in a single reactor system, for example a single loop reactor system, in which ethylene and optionally one or more α-olefins are polymerized in the presence of the catalyst system, as described within this disclosure, and optionally one or more cocatalysts, as described in the preceding paragraphs.

The ethylene-based polymers may further comprise one or more additives. Such additives include, but are not limited to, antistatic agents, color enhancers, dyes, lubricants, pigments, primary antioxidants, secondary antioxidants, processing aids, UV stabilizers, and combinations thereof. The ethylene-based polymers may contain any amounts of additives. The ethylene-based polymers may compromise from about 0 to about 10 percent by the combined weight of such additives, based on the weight of the ethylene-based polymers and the one or more additives. The ethylene-based polymers may further comprise fillers, which may include, but are not limited to, organic or inorganic fillers. The ethylene-based polymers may contain from about 0 to about 20 weight percent fillers such as, for example, calcium carbonate, talc, or Mg(OH)₂, based on the combined weight of the ethylene-based polymers and all additives or fillers. The ethylene-based polymers may further be blended with one or more polymers to form a blend.

In some embodiments, a polymerization process for producing an ethylene-based polymer may include polymerizing ethylene and at least one additional α-olefin in the presence of a catalyst system, wherein the catalyst system incorporates at least one metal-ligand complex of formula (I). The polymer resulting from such a catalyst system that incorporates the metal-ligand complex of formula (I) may have a density according to ASTM D792 (incorporated herein by reference in its entirety) from 0.850 g/cm³ to 0.970 g/cm³, from 0.870 g/cm³ to 0.950 g/cm³, from 0.870 g/cm³ to 0.920 g/cm³, or from 0.870 g/cm³ to 0.900 g/cm³, for example.

In embodiments, the polymer resulting from the catalyst system that includes the metal-ligand complex of formula (I) has a melt flow ratio (I₁₀/I₂) from 5 to 15, in which melt index 12 is measured according to ASTM D1238 (incorporated herein by reference in its entirety) at 190° C. and 2.16 kg load, and melt index I₁₀ is measured according to ASTM D1238 at 190° C. and 10 kg load. In other embodiments the melt flow ratio (I₁₀/I₂) is from 5 to 10, and in others, the melt flow ratio is from 5 to 9.

In some embodiments, the polymer resulting from the catalyst system that includes the metal-ligand complex of formula (I) has a melt index (I₂) from 0.1 to 100, in which melt index 12 is measured according to ASTM D1238 (incorporated herein by reference in its entirety) at 190° C. and 2.16 kg load.

In some embodiments, the polymer resulting from the catalyst system that includes the metal-ligand complex of formula (I) has a molecular-weight distribution (MWD) from 1.0 to 25, where MWD is defined as M_{w}/Mₙ with M_{w} being a weight-average molecular weight and Mₙ being a number-average molecular weight. In other embodiments, the polymers resulting from the catalyst system have a MWD from 1.5 to 6. Another embodiment includes a MWD from 1.5 to 3; and other embodiments include MWD from 2 to 2.5.

### SymRAD HT-GPC Analysis

The molecular weight data is determined by analysis on a hybrid Robot-Assisted Dilution High-Temperature Gel Permeation Chromatographer (Sym-RAD-GPC) built by Symyx/Dow. The polymer samples are dissolved by heating for 120 minutes at 160° C. in 1,2,4-trichlorobenzene (TCB) at a concentration of 10 mg/mL stabilized by 300 parts per million (ppm) of butylated hydroxyl toluene (BHT). Each sample was diluted to 1 mg/mL immediately before the injection of a 250 μL aliquot of the sample. The GPC is equipped with two Polymer Labs PLgel 10 μm MIXED-B columns (300×10 mm) at a flow rate of 2.0 mL/minute at 160° C. Sample detection is performed using a PolyChar IR4 detector in concentration mode. A conventional calibration of narrow polystyrene (PS) standards is utilized with apparent units adjusted to homo-polyethylene (PE) using known Mark-Houwink coefficients for PS and PE in TCB at this temperature.

### 1-Octene Incorporation IR Analysis

The running of samples for the HT-GPC analysis precedes the IR analysis. For the IR analysis, a 48-well HT silicon wafer is utilized for deposition and analysis of 1-octene incorporation of samples. For the analysis, the samples are heated to 160° C. for less than or equal to 210 minutes; the samples are reheated to remove magnetic GPC stir bars and are shaken with glass-rod stir bars on a J-KEM Scientific heated robotic shaker. Samples are deposited while being heated using a Tecan MiniPrep 75 deposition station, and the 1,2,4-trichlorobenzene is evaporated off the deposited wells of the wafer at 160° C. under nitrogen purge. The analysis of 1-octene is performed on the HT silicon wafer using a NEXUS 670 E.S.P. FT-IR.

### EXAMPLES

Examples 1 to 5 are synthetic procedures for intermediates of ligands, for ligands themselves, and for isolated metal-ligand complexes including the ligands. It should be understood that the synthetic procedures of Cat. 1 to 5 are provided to illustrate embodiments described in this disclosure and are not intended to limit the scope of this disclosure or its appended claims.

The synthetic protocols for Catalyst 1 (Cat-1) are published in WO 2021/155158.

The synthetic protocols for Catalyst 2 (Cat-2) are published in WO 2021/155158.

The synthetic protocols for Catalyst 3 (Cat-3) are published in WO 2021/155158.

The synthetic protocols for Catalyst 4 (Cat-4) are published in WO/2021243213.

The synthetic protocols for Catalyst 5 (Cat-5) are found in Internation Application U.S. Ser. No. 11/208,503B2, and published as WO2018/183056.

### Example 1—Continuous Process Polymerization Results

### Production of Examples

All raw materials (monomer and comonomer) and the process solvent (a narrow boiling range high-purity paraffinic and cycloparaffinic solvent) are purified with molecular sieves before introduction into the reaction environment. High purity hydrogen is supplied by shared pipeline and dried with molecular sieve. The reactor monomer feed stream is pressurized via a mechanical compressor to above reaction pressure. The solvent feed is pressurized via a pump to above reaction pressure. The comonomer feed is pressurized via a pump to above reaction pressure. The individual catalyst components are manually batch diluted to specified component concentrations with purified solvent and pressured to above reaction pressure. All reaction feed flows are measured with mass flow meters and independently controlled with metering pumps.

The comonomer feed is mechanically pressurized and can be injected into the process at several potential locations depending on reactor configuration which include: only the feed stream for the first reactor, only the feed stream for the second reactor, or both the first and second reactor feed streams independently. Some comonomer injection combinations are only possible when running dual reactor configuration.

Reactor configuration options include single reactor operation, dual series reactor operation, or dual parallel reactor operation.

The continuous solution polymerization reactor consists of a liquid full, adiabatic, and continuously stirred tank reactor (CSTR). Independent control of all solvent, monomer, comonomer, hydrogen, and catalyst component feeds is possible. The total feed stream to the reactor (solvent, monomer, comonomer, and hydrogen) is temperature controlled by passing the feed stream through a heat exchanger. The total feed to the polymerization reactor is injected into the reactor in one location. The catalyst components are injected into the polymerization reactor separate from the other feeds. An agitator in the reactor is responsible for continuously mixing of the reactants. An oil bath provides for some fine tuning of the reactor temperature control.

In dual series reactor configuration the effluent from the first polymerization reactor exits the first reactor and is added to the second reactor separate from the other feeds to the second reactor.

In dual parallel reactor configuration the effluent streams from the first and the second polymerization reactors are combined prior to any additional processing.

In all reactor configurations the final reactor effluent (second reactor effluent for dual series, the combined effluent for dual parallel, or the single reactor effluent) enters a zone where it is deactivated with the addition of and reaction with a suitable reagent (typically water). At this same reactor exit location other additives may also be added for polymer stabilization (Octadecyl 3,5-Di-Tert-Butyl-4-Hydroxyhydrocinnamate, Tetrakis(Methylene(3,5-Di-Tert-Butyl-4-Hydroxyhydrocinnamate))Methane, and Tris(2,4-Di-Tert-Butyl-Phenyl) Phosphite).

Following catalyst deactivation and any additive addition, the reactor effluent enters a devitalization system where the polymer is removed from the non-polymer stream. The non-polymer stream is removed from the system. The isolated polymer melt is pelletized and collected.

TABLE 1
Dual Reactor Dual Catalyst and Dual Reactor with Three Catalysts Configuration

| | | | | | | | | |
|---|---|---|---|---|---|---|---|---|
| Ex. No. | Ex. 1 | Ex. 2 | Ex. 3 | Ex. 4 | Ex. 5 | Ex. 6 | Ex. 7 | Ex. 8 |

Reactor 1

| | | | | | | | | |
|---|---|---|---|---|---|---|---|---|
| Catalyst A | Cat-4 | Cat-4 | Cat-4 | Cat-5 | Cat-5 | Cat-5 | Cat-5 | Cat-4 |
| Catalyst B | Cat-1 | Cat-1 | Cat-1 | — | — | — | — | — |
| Cat A/B ratio | 35/65 | 55/45 | 70/30 | — | — | — | — | — |
| Co-Catalyst 1 | MMAO | MMAO | MMAO | MMAO | MMAO | MMAO | MMAO-3a | MMAO |
| Co-Catalyst 2 | — | — | — | — | — | — | RIBS-2 | — |
| Co-Catalyst 1 | 776 | 343 | 187 | 85 | 461 | 118 | 51 | 328 |
| (ratio) | | | | | | | | |
| Co-Catalyst 2 | — | — | — | — | — | — | 1.1 | — |
| (ratio) | | | | | | | | |
| Temp (C.) | 150 | 150 | 150 | 160 | 160 | 160 | 160 | 161 |
| H₂ (mol %) | 0.3 | 0.11 | 0.17 | 0.31 | 0.31 | 0.15 | 0.26 | 0.4 |
| Solvent (kg/h) | 17.7 | 16.4 | 16.4 | 22.8 | 22.8 | 24.1 | 22.4 | 25.9 |
| C2 (kg/h) | 2.3 | 2.3 | 2.29 | 3.24 | 3.24 | 2.55 | 3.24 | 4.02 |
| C8 (kg/h) | 0.3 | 1.61 | 1.61 | 1.5 | 1.55 | 0.8 | 1.88 | 1.16 |
| C2 conversion | 85.5 | 85.3 | 85.2 | 72 | 71.6 | 88.2 | 70.5 | 66.1 |
| (%) | | | | | | | | |
| C8/olefin | 11.3 | 41.1 | 40.8 | 31.7 | 32.4 | 23.9 | 36.6 | 22.4 |

Reactor 2

| | | | | | | | | |
|---|---|---|---|---|---|---|---|---|
| Catalyst C | — | Cat-1 | Cat-1 | 2 | Cat-2 | Cat-2 | Cat-2 | Cat-2 |
| Co-Catalyst | — | — | — | — | — | — | — | — |
| Co-Catalyst | — | — | — | — | — | — | — | — |
| Temp (C.) | — | 190 | 190 | 190 | 190 | 190 | 190 | 190 |
| H₂ (mol %) | — | 1.89 | 1.89 | 1.51 | 1.57 | 2.38 | 1.9 | 5.83 |
| Solvent (kg/h) | — | 15.3 | 15.3 | 8.2 | 8.2 | 8.1 | 8.2 | 8.8 |
| C2 (kg/h) | — | 3.19 | 3.18 | 1.71 | 1.69 | 2.36 | 1.69 | 0.98 |
| C8 (kg/h) | — | 0 | 0 | 0.55 | 0.55 | 0 | 0.55 | 0.4 |
| C2 conversion | — | 85.2 | 85.5 | 82.1 | 82 | 82.1 | 82.3 | 78.9 |
| (%) | | | | | | | | |
| C8/olefin | — | 0 | 0 | 24.4 | 24.6 | 0 | 24.6 | 29 |
| Rx1 polymer | — | 40.6 | 41.4 | 57.2 | 57 | 54.8 | 56.6 | 64 |
| (%) | | | | | | | | |

Polymer Data

| | | | | | | | | |
|---|---|---|---|---|---|---|---|---|
| I2 (g/10 min) | 1.28 | 8.18 | 6.46 | 0.8 | 0.78 | 0.79 | 0.82 | 0.83 |
| Density (g/cc) | 0.9461 | 0.9604 | 0.956 | 0.9287 | 0.9276 | 0.9297 | 0.932 | 0.9282 |
| I0/I2 | 5.63 | 13.08 | 13.92 | 7.13 | 7.29 | 7.67 | 6.76 | 6.84 |
| Mw (g/mol) | 105,038 | 68,049 | 74,613 | 111,214 | 112,154 | 112,224 | 113,582 | 107,359 |
| Mn (g/mol) | 43,804 | 6,863 | 7,258 | 19,731 | 19,699 | 14,845 | 20,509 | 13,701 |
| PDI | 2.4 | 9.92 | 10.3 | 5.64 | 5.69 | 7.56 | 5.54 | 7.84 |

H₂ (mol %) is defined as the mole fraction of hydrogen, relative to ethylene, fed into the reactor. Ethylene conversion is measured as the difference between the ethylene fed to the reactor relative to the amount exiting the reactor, expressed as a percentage. C₈/olefin is the fresh C₈ feed divided by the total of the fresh C₈ and fresh C₂ feed. Co-catalyst ratio is the total molar ratio of Al from MMAO or MMAO-3a/to the total catalyst A and B metal or C metal or the molar ratio of bis(hydrogenated tallow alkyl)methyl, tetrakis(pentafluorophenyl)borate(1-)ammonium (RIBS-2) to catalyst A metal. Cat A/B ratio is a metal molar ratio of the two catalysts in the same reactor.

MMAO-3a is commercially available from Nouryon, and the CAS # is 146905-79-5. MMAO is modified with n-octyl substituents such that the methyl:n-octyl ratio is approximately 6:1

### Equipment Standards

All solvents and reagents are obtained from commercial sources and used as received unless otherwise noted. Anhydrous toluene, hexanes, tetrahydrofuran, and diethyl ether are purified via passage through activated alumina and, in some cases, Q-5 reactant. Solvents used for experiments performed in a nitrogen-filled glovebox are further dried by storage over activated 4 Å molecular sieves. Glassware for moisture-sensitive reactions is dried in an oven overnight prior to use. NMR spectra are recorded on Varian 400-MR and VNMRS-500 spectrometers. Chemical shifts for ¹H NMR data are reported in ppm downfield from internal tetramethylsilane (TMS, 6 scale) using residual protons in the deuterated solvent as references. ¹³C NMR data are determined with ¹H decoupling, and the chemical shifts are reported downfield from tetramethylsilane (TMS, 6 scale) in ppm versus the using residual carbons in the deuterated solvent as references.

1. A polymerization process comprising:
polymerizing ethylene and optionally one or more olefins in the presence of a catalyst system comprising at least one metal-ligand complex of formula (I), at least one group IV procatalyst, at least one additive, and optionally a Lewis acid, in a solution polymerization reactor under olefin polymerizing conditions to form an ethylene-based polymer, wherein the metal-ligand complex (precatalyst) of formula (I) has a structure according to: 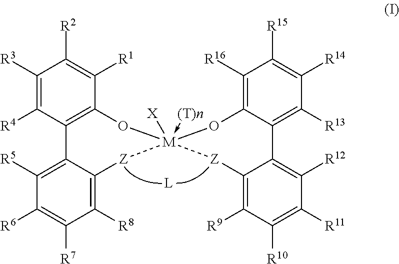
where:
M is scandium, yttrium, or a lanthanide metal;
each X is a ligand chosen from (C₁-C₄₀)hydrocarbyl, (C₁-C₄₀)heterohydrocarbyl, —CH₂Si(R^{C})₃-Q(OR^{C})_{Q}, —Si(R^{C})₃-Q(OR^{C})_{Q}, —OSi(R^{C})₃-Q(OR^{C})_{Q}, —CH₂Ge(R^{C})₃-Q(OR^{C})_{Q}, —Ge(R^{C})₃-Q(OR^{C})_{Q}, —P(R^{C})_{2-W}(OR^{C})_{W}, —P(O)(R^{C})_{2-W}(OR^{C})_{W}, —N(R^{C})₂, —NH(R^{C}), —N(Si(R^{C})₃)₂, —NR^{C}Si(R^{C})₃, —NHSi(R^{C})₃, —OR^{C}, —SR^{C}, —NO₂, —CN, —CF₃, —OCF₃, —S(O)R^{C}, —S(O)₂R^{C}, —OS(O)₂R^{C}, —N═C(R^{C})₂, —N═CH(R^{C}), —N═CH₂, —N═P(R^{C})₃, —OC(O)R^{C}, —C(O)OR^{C}, —N(R^{C})C(O)R^{C}, —N(R^{C})C(O)H, —NHC(O)R^{C}, —C(O)N(R^{C})₂, —C(O)NHR^{C}, —C(O)NH₂, B(R^{Y})₄, Al(R^{Y})₄, or Ga(R^{Y})₄, or a hydrogen, wherein each R^{C} is independently a substituted or unsubstituted (C₁-C₃₀)hydrocarbyl, or a substituted or unsubstituted (C₁-C₃₀)heterohydrocarbyl, and each Q is 0, 1, 2 or 3, and each W is 0, 1, or 2; each R^{Y} is —H, (C₁-C₃₀)hydrocarbyl, or halogen atom;
k is 1 or 2;
each T is independently Lewis Base;
n is 0, 1, or 2, when n is 1, X and T are optionally linked, when n is 2, X and one of T are optionally linked;
the metal-ligand complex is overall charge-neutral;
each Z is independently chosen from —O—, —S—, —N(R^{N})—, or —P(R^{P})—, wherein the dotted line optionally defines a dative bond;
R¹ and R¹⁶ are independently selected from the group consisting of (C₁-C₄₀)hydrocarbyl, (C₁-C₄₀)heterohydrocarbyl, —Si(R^{C})₃, —Ge(R^{C})₃, —P(R^{P})₂, —N(R^{N})₂, —OR^{C}, —SR^{C}, —NO₂, —CN, —CF₃, R^{C}S(O)—, R^{C}S(O)₂—, —N═C(R^{C})₂, R^{C}C(O)O—, R^{C}OC(O)—, R^{C}C(O)N(R)—, (R^{C})₂NC(O)—, or halogen;
R², R³, R⁴, R⁵, R⁶, R⁷, R⁸, R⁹, R¹⁰, R¹¹, R¹², R¹³, R¹⁴, and R¹⁵ are independently selected from —H, (C₁-C₄₀)hydrocarbyl, (C₁-C₄₀)heterohydrocarbyl, —Si(R^{C})₃, —Ge(R^{C})₃, —P(R^{P})₂, —N(R^{N})₂—OR^{C}, —SR^{C}, —NO₂, —CN, —CF₃, R^{C}S(O)—, R^{C}S(O)₂—, (R^{C})₂C═N—, (R^{C})₂P═N—, R^{C}C(O)O—, R^{C}OC(O)—, R^{C}C(O)N(R)—, (R^{C})₂NC(O)—, and halogen;
provided that when M is yttrium or a lanthanide metal, R¹ is not —H, phenyl or tert-butyl; and R¹⁶ is not —H, phenyl or tert-butyl;
L is (C₁-C₄₀)hydrocarbylene or (C₁-C₄₀)heterohydrocarbylene; and
each R^{C}, R^{P}, and R^{N} in formula (I) is independently a (C₁-C₃₀)hydrocarbyl, (C₁-C₃₀)heterohydrocarbyl, or —H.

2. The polymerization process of claim 1, wherein the polymerization reactor is a single reactor.

3. The polymerization process of claim 1, wherein the polymerization reactor is a dual reactor; and:
the metal-ligand catalyst of formula (I) is in a first reactor and the group (IV) catalyst is in a second reactor; or
the group (IV) catalyst is in a first reactor and the metal-ligand catalyst of formula (I) is in a second reactor; or
the metal-ligand catalyst of formula (I) and the group (IV) catalyst is in the first reactor and a second metal-ligand catalyst of formula (I) or a second group (IV) catalyst is in the second reactor; or
the metal-ligand catalyst of formula (I) and the group (IV) catalyst is in the second reactor and a second metal-ligand catalyst of formula (I) or a second group (IV) catalyst is in the first reactor.

4. The polymerization process of claim 1, wherein the polymerization reactor is a multi-zone reactor.

5. The polymerization process of claim 1, wherein the additive is an alkylating agent, a co-catalyst, or a scavenger.

6. The polymerization process of claim 1, wherein the additive is an alkyl aluminoxane compound, alkyl modified aluminoxane, or alkyl aluminum.

7. The polymerization process of claim 1, wherein the Lewis Acid is alkyl modified aluminoxane.

8. The polymerization process of claim 1, wherein the Lewis Acid is alkyl aluminum having a formula of AlR^{A}₃, where each R^{A} is independently (C₁-C₄₀)hydrocarbyl.

9. The polymerization process of claim 8, wherein each R^{A} is independently (C₁-C₄₀)alkyl.

10. The polymerization process of claim 1, wherein the additive comprises (A) at least one co-catalyst selected from the groups consisting of an aluminoxane or (B) at least one co-catalyst selected from the groups consisting of an alkyl aluminum of the formula AlR^{A1}R^{B1}R^{C1} or (C) at least one co-catalyst is selected from an aluminoxane and at least one activator selected from the groups consisting of an alkyl aluminum of the formula AlR¹R²R³, where R^{A1}, R^{B1}, and R^{C1} are independently (C₁-C₄₀)alkyl.

11. The polymerization process of claim 1, wherein the additive is a borate compound.

12. The polymerization process of claim 1, wherein at least one Lewis Acid is selected from the mixture of alkyl aluminum compound and boron-based Lewis Acid.

13. The polymerization process of claim 1, where R¹ and R¹⁶ are chosen from radicals having formula (II), radicals having formula (III), and radicals having formula (IV): 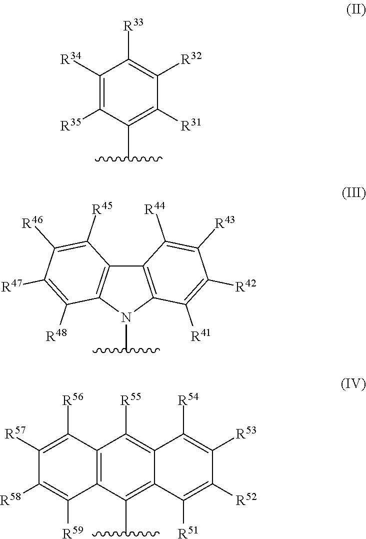
where each of R³¹⁻³⁵, R⁴¹⁻⁴⁸, and R⁵¹⁻⁵⁹ is independently chosen from —H, (C₁-C₄₀)hydrocarbyl, (C₁-C₄₀)heterohydrocarbyl, —Si(R^{C})₃, —Ge(R^{C})₃, —P(R^{P})₂, —N(R^{N})₂, —OR^{C}, —SR^{C}, —NO₂, —CN, —CF₃, R^{C}S(O)—, R^{C}S(O)₂—, (R^{C})₂C═N—, R^{C}C(O)O—, R^{C}OC(O)—, R^{C}C(O)N(R^{N})—, (R^{C})₂NC(O)—, or halogen; provided that when R¹ and R¹⁶ are formula (II), at least one of R³¹ to R³⁵ is not —H.

14. The polymerization process according to claim 1, wherein when M is scandium.

15. The polymerization process according to claim 1, wherein when M is yttrium or a lanthanide metal, at least one of R⁵⁻⁸ is not —H and at least one of R⁹⁻¹² is not —H.

16. The polymerization process according to claim 1, wherein at least one of R¹ and R¹⁶ is a radical having formula (III), wherein:
R⁴² and R⁴⁷ are (C₁-C₂₀)hydrocarbyl, —Si[(C₁-C₂₀)hydrocarbyl]₃, or —Ge[(C₁-C₂₀)hydrocarbyl]₃; or
R⁴³ and R⁴⁶ are (C₁-C₂₀)hydrocarbyl, —Si[(C₁-C₂₀)hydrocarbyl]₃, or —Ge[(C₁-C₂₀)hydrocarbyl]₃.

17. The polymerization process according claim 1, wherein at least one of R¹ and R¹⁶ is a radical having formula (II), wherein:
at least one of R³¹ to R³⁵ is not —H; or
R³² and R³⁴ are (C₁-C₂₀)hydrocarbyl, —Si[(C₁-C₂₀)hydrocarbyl]₃, or —Ge[(C₁-C₂₀)hydrocarbyl]₃.

18. The polymerization process according to claim 1, wherein at least one of R¹ and R¹⁶ is a radical having formula (IV), wherein:
at least two of R⁵², R⁵³, R⁵⁵, R⁵⁷, and R⁵⁸ are (C₁-C₂₀)hydrocarbyl, —Si[(C₁-C₂₀)hydrocarbyl]₃, or —Ge[(C₁-C₂₀)hydrocarbyl]₃; and
optionally R⁵² and R⁵³ are linked to form a cyclic structure, and optionally R⁵⁷ and R⁵⁸ are linked to form a cyclic structure.

19. The polymerization process according to claim 1, where L is chosen from —CH₂—, —CH₂(CH₂)ₘCH₂— where m is from 0 to 3, —CH₂Si(R^{C})₂CH₂—, —CH₂Ge(R^{C})₂CH₂—, —CH(CH₃)CH₂CH(CH₃), and —CH₂(phen-1,2-di-yl)CH₂—, where each R^{C} in L is (C₁-C₂₀)hydrocarbyl.

20. The polymerization process according to claim 1, wherein X is (C₆-C₂₀)aryl, benzyl, —CH₂Si[(C₁-C₂₀)alkyl]₃, (C₁-C₁₂)alkyl.

21. The polymerization process according to claim 1, wherein n is 1 or 2; and at least one T is (C₁-C₂₀)heterohydrocarbon, wherein the hetero atom of the heterohydrocarbon is oxygen.

22. The polymerization process according to claim 1, wherein n is 1 or 2; and at least one T is tetrahydrofuran, diethyl ether, or methyl tert-butyl ether (MTBE).

23. The polymerization process according to claim 1, wherein:
R², R⁴, R⁵, R¹², R¹³, and R¹⁵ are hydrogen; and
each Z is oxygen.

24. The polymerization process according to claim 1, wherein the Group (IV) metal-ligand complex is a bis-biphenylphenoxy Group IV metal-ligand complex having a structure according to formula (X): 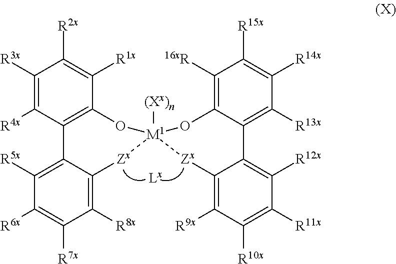
where M¹ is a metal chosen from titanium, zirconium, or hafnium;
each X^{x} is a monodentate ligand or bidentate ligand independently chosen from unsaturated (C₂-C₅₀)hydrocarbon, unsaturated (C₂-C₅₀)heterohydrocarbon, saturated (C₂-C₅₀)heterohydrocarbon, (C₁-C₅₀)hydrocarbyl, (C₆-C₅₀)aryl, (C₆-C₅₀)heteroaryl, cyclopentadienyl, substituted cyclopentadienyl, (C₄-C₁₂)diene, halogen, —N(R^{N})₂, and —NCOR^{C};
n is 1, 2, or 3; when n is 1, X^{x} is a monodentate ligand or a bidentate ligand, and when subscript n is 2, each X^{x} is a monodentate ligand;
the metal-ligand complex is overall charge-neutral;
each Z is independently chosen from —O—, —S—, —N(R^{N})—, or —P(R^{P})—;
L^{x} is (C₁-C₄₀)hydrocarbylene or (C₁-C₄₀)heterohydrocarbylene
R^{2x-4x}, R^{5x-8x}, R^{9x-12x} and R^{13x-15x} are independently selected from the group consisting of —H, (C₁-C₄₀)hydrocarbyl, (C₁-C₄₀)heterohydrocarbyl, —Si(R^{C})₃, —Ge(R^{C})₃, —P(R^{P})₂, —N(R^{N})₂, —OR^{C}, —SR^{C}, —NO₂, —CN, —CF₃, R^{C}S(O)—, R^{C}S(O)₂—, —N═C(R^{C})₂, R^{C}C(O)O—, R^{C}OC(O)—, R^{C}C(O)N(R)—, (R^{C})₂NC(O)—, and halogen;
R^{1x} and R^{16x} are selected from radicals having formula (XI), radicals having formula (XII), and radicals having formula (XIII): 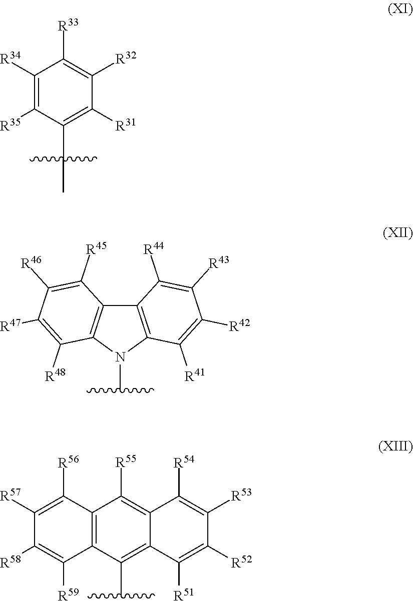
where each of R³¹⁻³⁵, R⁴¹⁻⁴⁸, and R⁵¹⁻⁵⁹ is independently chosen from —H, (C₁-C₄₀)hydrocarbyl, (C₁-C₄₀)heterohydrocarbyl, —Si(R^{C})₃, —Ge(R^{C})₃, —P(R^{P})₂, —N(R^{N})₂, —OR^{C}, —SR^{C}, —NO₂, —CN, —CF₃, R^{C}S(O)—, R^{C}S(O)₂—, (R^{C})₂C═N—, R^{C}C(O)O—, R^{C}OC(O)—, R^{C}C(O)N(R^{N})—, (R^{C})₂NC(O)—, or halogen.

25. The polymerization process according to claim 1, wherein the Group (IV) metal-ligand complex is a constrained-geometry Group IV complex having a structure according to formula (XV): 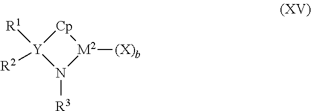
M² is titanium, hafnium or zirconium;
b is 1, 2, or 3;
each X is a monodentate ligand or bidentate ligand independently chosen from unsaturated (C₂-C₅₀)hydrocarbon, unsaturated (C₂-C₅₀)heterohydrocarbon, saturated (C₂-C₅₀)heterohydrocarbon, (C₁-C₅₀)hydrocarbyl, (C₆-C₅₀)aryl, (C₆-C₅₀)heteroaryl, cyclopentadienyl, substituted cyclopentadienyl, (C₄-C₁₂)diene, halogen, —N(R^{N})₂, and —NCOR^{C};
the metal-ligand complex is overall charge-neutral;
Cp is selected from the group consisting of cyclopentadienyl and R^{S} substituted cyclopentadienyl, the Cp being bound in an η⁵ bonding mode to M², wherein R^{S} is independently selected from the group consisting of (C₁-C₂₀)alkyl, (C₁-C₂₀)heteroalkyl, (C₁-C₂₀)aryl, or R^{S} substituent (C₁-C₂₀)aryl, (C₁-C₂₀)heteroaryl, or R^{S} substituent (C₁-C₂₀)heteroaryl, wherein two adjacent R^{S} groups are optionally linked to form a ring;
N is nitrogen;
Y is carbon or silicon; wherein Y is covalently bonded to Cp; and
R¹ and R² are independently selected from —H, (C₁-C₄₀)hydrocarbyl, and (C₁-C₄₀)heterohydrocarbyl; and R³ are independently selected from (C₁-C₄₀)hydrocarbyl, and (C₁-C₄₀)heterohydrocarbyl.

26. A polymerization process comprising:
polymerizing ethylene and optionally one or more olefins in the presence of a catalyst system comprising at least one olefin propagating catalytic species according to formula (Ia): at least one olefin propagating catalytic species of a group IV catalyst, at least one additive, and optionally a Lewis acid, in a solution polymerization reactor under olefin polymerizing conditions to form an ethylene-based polymer, wherein the olefin propagating catalytic species of (Ia) has a structure according to: 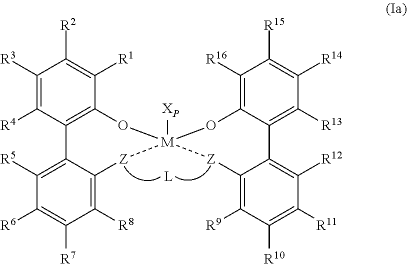
where:
M is scandium, yttrium, or a lanthanide metal;
X_{P} is a ligand chosen from hydrocarbyl, wherein the hydrocarbyl is branched or unbranched having at least 30 carbon atoms;
each Z is independently chosen from —O—, —S—, —N(R^{N})—, or —P(R^{P})—, wherein the dotted line optionally defines a dative bond;
R¹ and R¹⁶ are independently selected from the group consisting of (C₁-C₄₀)hydrocarbyl, (C₁-C₄₀)heterohydrocarbyl, —Si(R^{C})₃, —Ge(R^{C})₃, —P(R^{P})₂, —N(R^{N})₂, —OR^{C}, —SR^{C}, —NO₂, —CN, —CF₃, R^{C}S(O)—, R^{C}S(O)₂—, —N═C(R^{C})₂, R^{C}C(O)O—, R^{C}OC(O)—, R^{C}C(O)N(R)—, (R^{C})₂NC(O)—, or halogen;
R², R³, R⁴, R⁵, R⁶, R⁷, R⁸, R⁹, R¹⁰, R¹¹, R¹², R¹³, R¹⁴, and R¹⁵ are independently selected from —H, (C₁-C₄₀)hydrocarbyl, (C₁-C₄₀)heterohydrocarbyl, —Si(R^{C})₃, —Ge(R^{C})₃, —P(R^{P})₂, —N(R^{N})₂—OR^{C}, —SR^{C}, —NO₂, —CN, —CF₃, R^{C}S(O)—, R^{C}S(O)₂—, (R^{C})₂C═N—, (R^{C})₂P═N—, R^{C}C(O)O—, R^{C}OC(O)—, R^{C}C(O)N(R)—, (R^{C})₂NC(O)—, and halogen;
provided that when M is yttrium or a lanthanide metal, R¹ is not —H, phenyl or tert-butyl;
and R¹⁶ is not —H, phenyl or tert-butyl;
L is (C₁-C₄₀)hydrocarbylene or (C₁-C₄₀)heterohydrocarbylene; and
each R^{C}, R^{P}, and R^{N} in formula (I) is independently a (C₁-C₃₀)hydrocarbyl, (C₁-C₃₀)heterohydrocarbyl, or —H.

27. The polymerization process of claim 26, wherein M is yttrium or a lanthanide metal, at least one of R⁵⁻⁸ is not —H and at least one of R⁹⁻¹² is not —H.

28. The olefin propagating catalytic species of claim 26, where R¹ and R¹⁶ are chosen from radicals having formula (II), radicals having formula (III), and radicals having formula (IV): 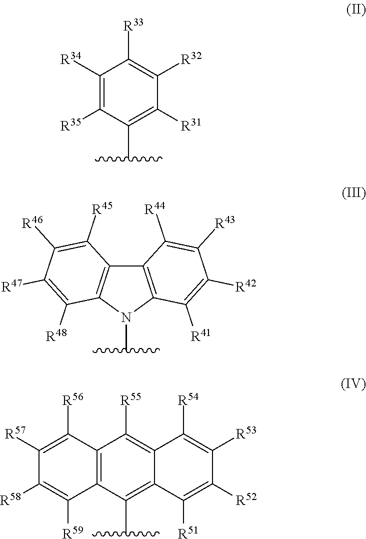
where each of R³¹⁻³⁵, R⁴¹⁻⁴⁸, and R⁵¹⁻⁵⁹ is independently chosen from —H, (C₁-C₄₀)hydrocarbyl, (C₁-C₄₀)heterohydrocarbyl, —Si(R^{C})₃, —Ge(R^{C})₃, —P(R^{P})₂, —N(R^{N})₂, —OR^{C}—SR^{C}, —NO₂, —CN, —CF₃, R^{C}S(O)—, R^{C}S(O)₂—, (R^{C})₂C═N—, R^{C}C(O)O—, R^{C}OC(O)—, R^{C}C(O)N(R^{N})—, (R^{C})₂NC(O)—, or halogen; provided that when R¹ and R¹⁶ are formula (II), at least one of R³¹ to R³⁵ is not —H.
